(19) United States
(12) Patent Application Publication
(10) Pub. No.: US 2026/0114546 A1
(43) Pub. Date: Apr. 30, 2026

(54) ARTICLE OF FOOTWEAR HAVING A SOLE STRUCTURE WITH MONOLITHIC COMPONENT OF STACKED LAYERS

(71) Applicant: NIKE, Inc., Beaverton, OR (US)

(72) Inventors: Kassio Figur, Portland, OR (US); Matthew D. Nordstrom, Portland, OR (US); Denis Schiller, Vancouver, WA (US)

(73) Assignee: NIKE, Inc., Beaverton, OR (US)

(21) Appl. No.: 19/374,029

(22) Filed: Oct. 30, 2025

Related U.S. Application Data
(60) Provisional application No. 63/714,373, filed on Oct. 31, 2024.

(51) Int. Cl. A43B 13/02; A43B 1/10; B29D 35/08; B29D 35/14

(52) U.S. Cl. CPC A43B 13/023; A43B 1/10; B29D 35/085; B29D 35/142

(57) ABSTRACT

An article of footwear includes a sole structure. The sole structure has layers stacked on one another. Adjacent ones of the layers are secured to one another by thermal bonds and without adhesive such that the layers define a monolithic component having a proximal side and a distal side. The layers are stacked in a direction from the proximal side to the distal side. At least two of the layers are exposed at the distal side, and have at least one different property. A method of manufacturing an article of footwear may include stacking the multiple layers without adhesive between adjacent ones of the multiple layers.

### CROSS-REFERENCE TO RELATED APPLICATIONS

This application claims the benefit of priority to United States Provisional Application No. 63/714,373, filed October 31, 2024, which is hereby incorporated by reference in its entirety.

### TECHNICAL FIELD

The present disclosure generally relates to an article of footwear and a method of manufacturing an article of footwear to provide a sole structure having a monolithic component formed from stacked layers.

### BACKGROUND

Footwear sole structures often include multiple components comprising different materials in order to serve various wear and cushioning needs. The components are sometimes secured to one another with adhesive. Some of the components may include cross-linked rubber. Excess materials from the manufacture of sole structures that include cross-linked rubber and/or adhesive may be difficult to recycle or reuse.

### BRIEF DESCRIPTION OF THE DRAWINGS

The drawings described herein are for illustrative purposes only, are schematic in nature, and are intended to be exemplary rather than to limit the scope of the disclosure.

FIG. 1 is a medial side view of an article of footwear including a sole structure having a monolithic component of multiple stacked rubber layers.

FIG. 2 is a plan view of an uncured rubber sheet on a backing layer.

FIG. 3 is a plan view of an uncured rubber layer for the sole structure of FIG. 1 after cutting the uncured rubber sheet of FIG. 2.

FIG. 4 is a plan view of the uncured rubber layer of FIG. 3 removed from the backing layer.

FIG. 5 is a plan view of another cut, uncured rubber layer for the sole structure of FIG. 1.

FIG. 6 is a plan view of another cut, uncured rubber layer for the sole structure of FIG. 1.

FIG. 7 is a plan view of the uncured rubber layers of FIGS. 4-6 stacked on one another.

FIG. 8 is a fragmentary cross-sectional view of an example of a monolithic component of a sole structure including stacked rubber layers and shown resting on a ground plane.

FIG. 9 is a fragmentary cross-sectional view of the monolithic component of FIG. 8 under compressive forces.

FIG. 10 is a fragmentary cross-sectional view of another example of a monolithic component of a sole structure including stacked rubber layers and shown resting on a ground plane.

FIG. 11 is a fragmentary cross-sectional view of the monolithic component of FIG. 10 under compressive forces.

FIG. 12 is a fragmentary cross-sectional view of another example of a monolithic component of a sole structure including stacked rubber layers and shown resting on a ground plane.

FIG. 13 is a cross-sectional view of a cutting machine showing an uncured rubber layer for any of the sole structures herein in the process of being cut.

FIG. 14 is a fragmentary cross-sectional view of a mold having recesses for registering multiple uncured rubber layers during stacking.

FIG. 15 is a fragmentary cross-sectional view of the mold of FIG. 14 showing the multiple uncured rubber layers stacked in the recesses.

FIG. 16 is a cross-sectional view of a mold showing multiple uncured rubber layers registered to the mold and a midsole preform in the mold cavity.

FIG. 17 is a cross-sectional view of a mold showing multiple rubber layers registered to the mold and showing foam for a midsole being injected into the mold cavity.

FIG. 18 is a cross-sectional view of a mold showing multiple uncured rubber layers registered to the mold and showing a lasted footwear upper inserted into the mold cavity.

FIG. 19 is a plan view of a cut uncured rubber layer for the sole structure of FIGS. 23-26.

FIG. 20 is a plan view of another cut, uncured rubber layer for the sole structure of FIGS. 23-26.

FIG. 21 is a plan view of another cut, uncured rubber layer for the sole structure of FIGS. 23-26.

FIG. 22 is a plan view of another cut, uncured rubber layer for the sole structure of FIGS. 23-26.

FIG. 23 is a top lateral perspective view of a monolithic component for a sole structure after stacking the uncured rubber layers of FIGS. 19-22 and curing to secure the rubber layers to one another.

FIG. 24 is a bottom perspective view of the monolithic component of FIG. 23.

FIG. 25 is a lateral perspective view of an article of footwear including a sole structure with the monolithic component of FIGS. 23-24.

FIG. 26 is a lateral perspective view of another article of footwear including a sole structure with the monolithic component of FIGS. 23-24.

FIG. 27 is a bottom perspective view of another article of footwear including a sole structure having a monolithic component of multiple stacked rubber layers.

FIG. 28 is a bottom perspective view of another article of footwear including a sole structure having a monolithic component of multiple stacked rubber layers.

FIG. 29 is a bottom perspective view of another article of footwear including a sole structure having a monolithic component of multiple stacked rubber layers.

FIG. 30 is a plan view of a cut uncured rubber layer for the sole structure included in the article of footwear of FIG. 34.

FIG. 31 is a plan view of another cut, uncured rubber layer for the sole structure of FIG. 34.

FIG. 32 is a plan view of another cut, uncured rubber layer for the sole structure of FIG. 34.

FIG. 33 is a plan view of another cut, uncured rubber layer for the sole structure of FIG. 34.

FIG. 34 is a bottom perspective view of an article of footwear including a sole structure having a monolithic component after stacking the uncured rubber layers of FIGS. 30-33 and curing to secure the rubber layers to one another.

### DESCRIPTION

The present disclosure generally relates to an article of footwear and a method of manufacturing an article of footwear that promotes sustainability while still meeting functional and design objectives. Specifically, by assembling the components during manufacture utilizing layers of material without adhesive between the layers, and securing the layers to one another by a thermal process after cutting the layers, any scrap material may be recyclable. For example, if the layers are uncured rubber with no adhesive between the layers, and the uncured rubber layers are cured after cutting, the gathered scrap material will be free of cross-linking and adhesive and thus better suited for recycling and reuse in a future footwear manufacturing process.

In an example, an article of footwear includes a sole structure. The sole structure has rubber layers stacked on one another. Adjacent ones of the rubber layers are secured to one another with cross-linking and without adhesive such that the rubber layers define a monolithic component having a proximal side and a distal side. The rubber layers are stacked in a direction from the proximal side to the distal side. At least two of the rubber layers are exposed at the distal side, and have at least one different property.

It should be understood that, because the uncured rubber layers cure such that they secure to one another with cross-linking and without adhesive, the cured layers may alternatively be referred to as regions of the monolithic component and the monolithic component may thus be considered a single layer, with the regions distinct in that they each may have at least one different property as discussed herein. For example, the sole structure may be described as a monolithic component comprising regions of cured rubber disposed in a direction from a proximal side of the monolithic component to a distal side of the monolithic component. Each of the regions may have at least one different property than each of the other regions, as discussed herein, with adjacent ones of the regions secured to one another by cross-linking and without adhesive therebetween. At least two of the regions may be exposed at the distal side.

In an implementation, at least two of the rubber layers may at least partially define a ground contact surface of the sole structure at the distal side. In one or more configurations, the at least two of the rubber layers defining the ground contact surface may comprise an outsole.

In a configuration, the article of footwear may further include a footwear upper, and the monolithic component may wrap upward onto and be secured to the footwear upper at a medial side of the footwear upper and at a lateral side of the footwear upper.

In some implementations, such as but not limited to when the monolithic component is secured directly to the footwear upper, the sole structure may include a drop-in midsole disposed in a foot-receiving cavity of the article of footwear.

As used herein, a “drop-in midsole” is a midsole that is placed in a foot-receiving cavity defined by a footwear upper that is already secured to remaining components of the sole structure, such as an outsole. As such, the drop-in midsole is completely contained within the foot-receiving cavity, is surrounded at its periphery by the footwear upper, and the footwear upper is exterior to the drop-in midsole.

In some implementations, the sole structure may include a foam midsole layer disposed inward of the proximal side of the monolithic component.

In some configurations, the rubber layers may define at least partially aligned through holes extending through the monolithic component from the proximal side to the distal side. The foam midsole layer may be exposed from the distal side at the through holes. In some examples, the foam midsole layer may extend at least partially through at least some of the through holes toward the distal side.

In an aspect, the monolithic component may wrap upward onto and be secured to the foam midsole layer at a medial side of the foam midsole layer and at a lateral side of the foam midsole layer.

In an example, the at least two of the rubber layers that are exposed at the distal side may include a first rubber layer and a second rubber layer. The first rubber layer and the second rubber layer may define a protrusion at the distal side of the article of footwear. The first rubber layer may be disposed as an outermost portion of the protrusion along a vertical axis of the protrusion. The second rubber layer may be exposed along the protrusion proximal to the first rubber layer.

A protrusion at the distal side of the article of footwear may include layers or regions as discussed herein, with an outermost one of the layers or regions having a lesser fore-aft expanse and/or a lesser transverse expanse than an adjacent and more proximal one of the layers or regions such that both the outermost one of the layers or regions and the more proximal one of the layers or regions are exposed at the distal side of the article of footwear.

In an example, at a cross-section taken along a vertical plane and through the sole structure when the sole structure is resting on a ground plane with a distal-most one of the layers or regions forming at least a portion of the ground contact surface, a more proximal one of the layers or regions of the sole structure will have a greater width along an X-Y plane than a more distal one of the layers or regions.

One or more protrusions at the distal side of the sole structure form a topography of the sole structure when the sole structure rests on a ground plane with a distal-most one of the layers or regions forming at least a portion of the ground contact surface. In such an orientation, a lower surface of a more proximal one of the layers or regions will be exposed at and form a portion of the distal side or ground-facing surface of the sole structure around the more distal one of the layers or regions. Stated differently, the distal side or ground-facing surface of the sole structure will include at least the distal-most one of the layers or regions and a more proximal one of the layers or regions.

Within the scope of the disclosure, a protrusion as discussed herein that includes both the outermost one of the layers or regions and a more proximal one of the layers or regions exposed at the distal side or ground-facing surface of the article of footwear may have a variety of shapes including, but not limited to, a rounded or conical shape, or a more extended ridge-like shape, which ridge may be linear or curvilinear.

In an aspect, the first rubber layer may have a first hardness and the second rubber layer may have a second hardness different than the first hardness.

In some configurations, the rubber layers may also include a third rubber layer disposed adjacent to the second rubber layer with the second rubber layer between the first rubber layer and the third rubber layer. The third rubber layer may have a third hardness different than the second hardness.

In some implementations having the third rubber layer, the protrusion may include the first rubber layer and the second rubber layer and not the third rubber layer.

In some implementations, the protrusion may extend laterally across a longitudinal midline of the monolithic component. In the same or other implementations, the protrusion may extend fore and aft in a nonlinear orientation. Still further, in some implementations, the first rubber layer may include discrete strips extending transversely from a medial side to a lateral side of the sole structure.

In some implementations, a proximal side of the first rubber layer and a distal side of the second rubber layer meet at and define an interface where originally stacked on one another. The first rubber layer may have a first color at the interface and the second rubber layer may have a second color different than the first color at the interface. Curing the rubber layers together as a monolithic component after stacking may help to ensure a very distinct and crisp boundary between the colors at the interface.

In an aspect, at least one of the rubber layers may have a recess extending partway or completely through a thickness of the at least one of the rubber layers. If the recess extends only partway through, it may be used for locating and nesting the next adjacent rubber layer during the initial stacking of the rubber layers. For example, the nested rubber layer may have a thickness equal to that of the recess such that an upper surface of the nested rubber layer is even in height with that of the layer in which it nests. In an example in which the recess extends completely through as a through hole, such as where the first rubber layer defines a through hole extending through the first rubber layer, the through hole may expose at least one other of the rubber layers at the through hole.

In some configurations, at least two of the rubber layers may have discrete, discontinuous sections. The sections of at least two of the rubber layers may be stacked in a different order relative to one another in a first region of the article of footwear than in a second region of the article of footwear. In this manner, different physical properties or different design aspects of the rubber layers may be utilized in correlation with the different regions.

In some implementations, at least one of the rubber layers may define a plurality of medial fingers at a medial extent of the at least one of the rubber layers that may establish a medial edge of the at least one of the rubber layers. The same rubber layer or layers may also have a plurality of lateral fingers at a lateral extent of the at least one of the rubber layers that may establish a lateral edge of the at least one of the rubber layers.

In an example, one or more of the rubber layers may be interwoven with one or more of the other rubber layers. For example, the rubber layers may include a first rubber layer that has a plurality of discrete sections spaced apart from one another, a second rubber layer having a distal side secured to a proximal side of the discrete sections of the first rubber layer, and an additional rubber layer that has a proximal side that interfaces with the distal side of the second rubber layer and with the proximal side of at least one of the discrete sections and is cross-linked thereto, and interfaces with a distal side of at least one other of the discrete sections and is cross-linked thereto.

The additional rubber layer is thus interwoven with the discrete sections of the first rubber layer and has portions that may define a portion of the distal side and ground contact surface of the monolithic component, for example. In an implementation, the additional rubber layer may extend lengthwise in a fore-aft direction of the sole structure.

In an example, an article of footwear includes a sole structure. The sole structure has layers stacked on one another. Adjacent ones of the layers are secured to one another with thermal bonds created by heat and, in some instances, pressure, and without adhesive such that the layers define a monolithic component having a proximal side and a distal side. The layers are stacked in a direction from the proximal side to the distal side. At least two of the layers are exposed at the distal side, and have at least one different property. In an example, the layers could be rubber layers cured together. In another example, the layers could be thermoplastic polyurethane.

Within the scope of the disclosure, a method of manufacturing an article of footwear may include stacking multiple uncured rubber layers without adhesive between adjacent ones of the multiple uncured rubber layers. After the stacking is completed, the method of manufacturing may include curing the multiple uncured rubber layers as a monolithic component of a sole structure of the article of footwear such that adjacent ones of the rubber layers are secured to one another by cross-linking (and without adhesive). The resulting monolithic component may have a distal side and a proximal side. The rubber layers may be stacked in a direction from the proximal side to the distal side, and at least two of the rubber layers may be exposed at the distal side and have at least one different property.

In an aspect, the at least two of the rubber layers that are exposed at the distal side may at least partially define a ground contact surface of the sole structure.

The at least two of the rubber layers that are exposed at the distal side may include a first rubber layer and a second rubber layer. The method of manufacturing the article of footwear may further include forming or cutting the rubber layers prior to curing so that scraps cut away from the uncured rubber layers have no cross-linking or adhesive and are thus readily recyclable. Forming or cutting the uncured rubber layers may result in shapes such that, once stacked: (i) at least the first rubber layer and the second rubber layer define a protrusion at the distal side of the monolithic component; (ii) the first rubber layer and the second rubber layer define a protrusion at the distal side of the article of footwear; (iii) the first rubber layer is disposed as an outermost portion of the protrusion along a vertical axis of the protrusion; and (iv) the second rubber layer is exposed along the protrusion proximal to the first rubber layer.

In an implementation, the at least two of the rubber layers that are exposed at the distal side may include a first rubber layer and a second rubber layer, and the method of manufacturing an article of footwear may further include forming or cutting through holes in at least the first rubber layer and the second rubber layer prior to the stacking. The stacking multiple uncured rubber layers may include at least partially aligning the through holes in the first rubber layer with the through holes in the second rubber layer.

In an aspect, the stacking multiple uncured rubber layers may be in a mold, and the method of manufacturing the article of footwear may include injecting foam into the mold to form a foam midsole layer such that the injected foam extends through the at least partially aligned through holes.

In another aspect, the at least two of the rubber layers exposed at the distal side may include a first rubber layer and a second rubber layer, the stacking multiple uncured rubber layers may include registering the first uncured rubber layer to a mold within a mold cavity of the mold prior to stacking the second uncured rubber layer on the first rubber layer, and the curing of the rubber layers may be in the mold. A surface of the mold could be configured to impart a texture on the first rubber layer and/or any of the other rubber layers in contact with the surface of the mold.

In another aspect, the at least two of the rubber layers exposed at the distal side may include a first rubber layer and a second rubber layer, and the method of manufacturing may include forming or cutting through holes in at least the first rubber layer and the second rubber layer either prior to or after the stacking and prior to the curing. In such an implementation, the method of manufacturing may further include ejecting cut portions of the stacked multiple layers at the through holes via a die.

In some implementations, the stacking multiple uncured rubber layers may be in a mold. In such implementations, the method of manufacturing the article of footwear may further include injecting foam into the mold to form a foam midsole layer and such that the injected foam extends through the at least partially aligned through holes. In an example, the injecting of the foam may occur after curing the stacked rubber layers. Alternatively, the method of manufacturing may include placing a preform of a foam midsole layer in the mold prior to the curing such that the preform forms a foam midsole layer and the monolithic component thermally bonds to the foam midsole layer during or after the curing.

In yet another alternative, the method of manufacturing may include placing a footwear upper in the mold prior to the curing such that the monolithic component thermally bonds to the footwear upper during or after the curing.

In such an implementation in which the monolithic component is thermally bonded to the footwear upper in the mold, the method of manufacturing may include placing a drop-in midsole into a foot-receiving cavity of the footwear upper. For example, if the footwear upper extends completely under the foot from the medial side to the lateral side (e.g., a sock-like upper), then the drop-in midsole is provided within the upper.

In an example, the at least two of the rubber layers exposed at the distal side of the monolithic component may include a first rubber layer having discrete sections spaced apart from one another and a second rubber layer interfacing with a proximal side of the discrete sections of the first rubber layer. Stacking the multiple rubber layers prior to curing may include intertwining an additional uncured rubber layer with the discrete sections of the first uncured rubber layer so that the additional uncured rubber layer interfaces with a distal side of at least one of the discrete sections and with the proximal side of at least one other of the discrete sections.

In an example, a method of manufacturing an article of footwear may include stacking multiple uncured rubber layers without adhesive between adjacent ones of the multiple uncured rubber layers and such that through holes of at least some of the stacked multiple uncured layers are at least partially aligned with one another. The method may further include curing the stacked multiple uncured rubber layers as a monolithic component such that adjacent ones of the cured rubber layers are secured to one another by cross-linking.

The method of manufacturing may further include cutting the through holes either prior to or after the stacking and prior to the curing. In such an implementation, the method of manufacturing may further include ejecting cut portions of the stacked multiple layers at the through holes via a die.

In some implementations, the method of manufacturing may include cutting a recess only partway through a depth of at least one of the multiple uncured rubber layers either prior to or after the stacking.

In an aspect of the method of manufacturing, at least one of the multiple uncured rubber layers may have a sufficiently soft durometer such that friction between the at least one of the multiple uncured rubber layers and an adjacent one of the multiple uncured rubber layers prevents shifting of the adjacent ones of the multiple uncured rubber layers after the stacking and prior to the curing.

Within the scope of the disclosure, a method of manufacturing an article of footwear may include stacking multiple layers without adhesive between adjacent ones of the multiple layers. After the stacking is completed, the method of manufacturing may include applying heat and pressure to the multiple layers such that they become a monolithic component of a sole structure of the article of footwear secured to one another by thermal bonding (and without adhesive). The resulting monolithic component may have a distal side and a proximal side. The layers may be stacked in a direction from the proximal side to the distal side, and at least two of the layers may be exposed at the distal side and have at least one different property.

The above features and advantages and other features and advantages of the present teachings are readily apparent from the following detailed description of the modes for carrying out the present teachings when taken in connection with the accompanying drawings. It should be understood that, even though in the following Figures embodiments may be separately described, single features thereof may be combined to additional embodiments.

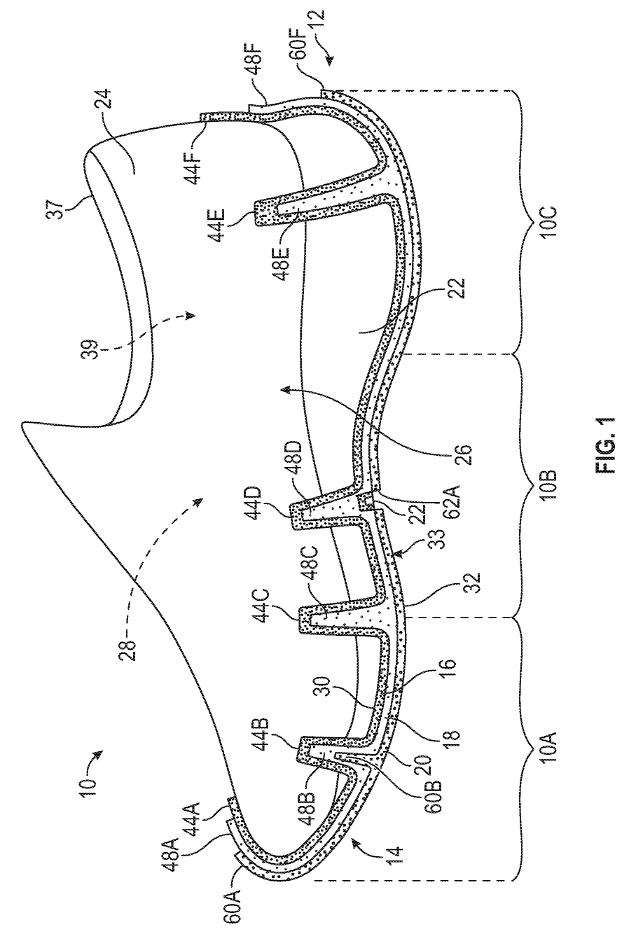

FIG. 1 is a medial side view of an article of footwear 10 including a sole structure 12 with a monolithic component 14. The monolithic component 14 has multiple stacked rubber layers 16, 18, and 20 as discussed herein and is configured as an outsole in the embodiment shown. Accordingly, the monolithic component 14 may alternatively be referred to as an outsole. In the embodiment shown, the sole structure 12 also includes a foam midsole layer 22. The article of footwear includes a footwear upper 24 secured to the sole structure 12. The footwear upper 24 defines an ankle opening 37 and a foot-receiving cavity 39 over the sole structure 12.

The article of footwear 10 includes a forefoot region 10A, a midfoot region 10B, and a heel region 10C. The forefoot region 10A generally includes portions of the article of footwear 10 corresponding with the toes and the joints connecting the metatarsals with the phalanges of a wearer’s foot. The midfoot region 10B generally includes portions of the article of footwear 10 corresponding with the arch area of the foot, and the heel region 10C corresponds with rear portions of the foot, including the calcaneus bone.

The article of footwear 10 includes a medial side 26 and a lateral side 28 that extend through each of forefoot region 10A, the midfoot region 10B, and the heel region 10C and fall on opposite sides of a longitudinal midline of the article of footwear 10. The forefoot region 10A, the midfoot region 10B, the heel region 10C, the medial side 26, and the lateral side 28 also refer to regions and sides of the individual components of the article of footwear 10, and are not intended to demarcate precise areas of footwear 10, but are instead intended to represent general areas of the article of footwear 10, the footwear upper 24, the sole structure 12, and the monolithic component 14, etc., to aid in the following discussion.

The monolithic component 14 is shown wrapping upward onto and secured to both the foam midsole layer 22 and the footwear upper 24 at the medial side 26 and at the lateral side 28 (the fingers 44A, 44B, 44C, 44G, 44H, 44I, and 44J of FIG. 7 wrap up onto and are secured to the foam midsole layer 22 and the footwear upper 24 at the lateral side 28 as discussed). The foam midsole layer 22 is disposed inward of the proximal side 30 of the monolithic component 14, which is the proximal side 30 of the rubber layer 16, referred to herein as the third rubber layer.

The distal side 32 of the monolithic component 14 is the outward-facing side of the rubber layer 20 indicated in FIGS. 1, 6, and 7 (referred to herein as the first rubber layer) in the completed sole structure 12, may also be referred to as the distal side 32 of the first rubber layer 20 and/or the distal side 32 of the sole structure 12. The distal side 32 at least partially forms the ground contact surface 33 of the sole structure 12.

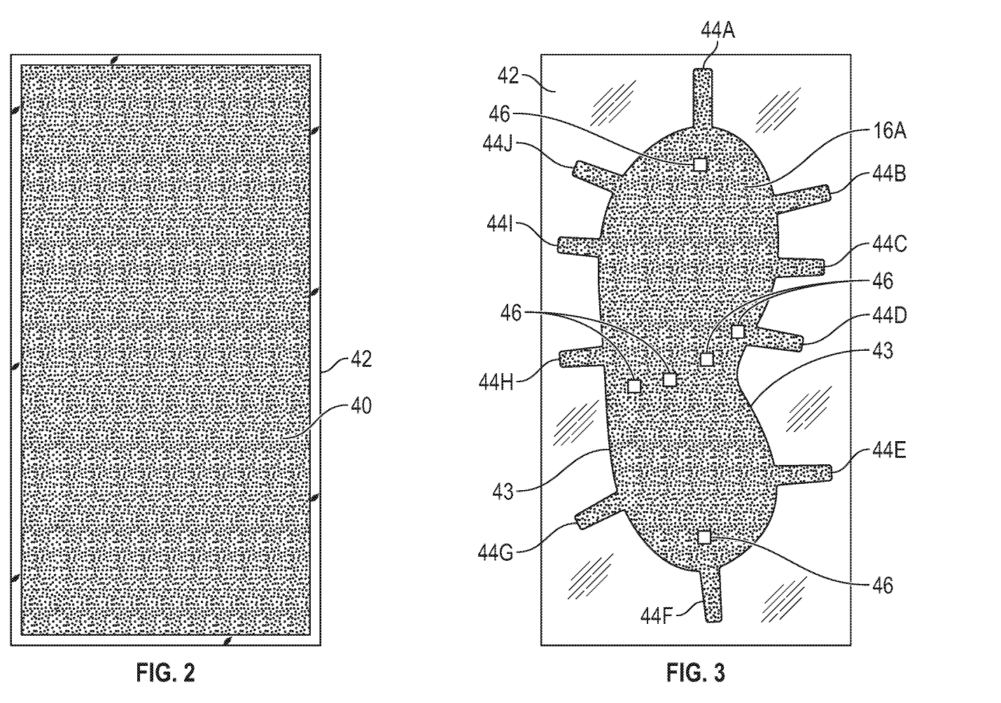

As discussed in greater detail with respect to FIGS. 2-7, adjacent ones of the rubber layers 16, 18, and 20 are secured to one another with cross-linking and without adhesive such that the rubber layers 16, 18, and 20 define the monolithic component 14 having the proximal side 30 and the distal side 32. As used herein, “adhesive” includes any adhesive material such as but not limited to double-sided adhesive tape, glue, cement, or any other bonding material. Due to cross-linking and the absence of adhesive at the interfaces, once cured as a monolithic component, there are no longer distinct surfaces between adjacent cured rubber layers 16, 18, and 20, and the cured rubber layers 16, 18, and 20 may alternatively be referred to as first, second, and third regions of the monolithic component 14, which may be considered a single layer resulting from the curing of stacked uncured rubber layers 16A, 18A, and 20A discussed herein. Each of the regions may have at least one physical property that differs from that of each adjacent region, as discussed herein.

As such, as used herein, a component is “monolithic” if it has multiple regions of a single material and is characterized by an absence of distinct surfaces between the adjacent regions. The single material may be, for example, a rubber material that has one or more different characteristics in each of the different adjacent layers or regions as discussed herein.

By contrast, two layers of a single material do not become monolithic as used herein if bonded together by another material disposed between the two layers. In such a case, each layer retains a distinctly identifiable boundary. For example, even if adjacent regions of a component are bonded together with an adhesive material that is different from the single material, such that the adhesive material is interposed between and forms an uninterrupted layer in physical contact with and adhering to opposing surfaces of each of the adjacent regions throughout an area between the adjacent regions, such component is not considered “monolithic” as used in this description and accompanying claims because each of the regions retains a distinct surface to which the adhesive material is adhered.

The single material may be a cured rubber material and the multiple regions of a component (such as regions or layers 16, 18, and 20 of component 14) are together considered “monolithic” as used in the description and accompanying claims, and including a first region 20 in which the cured rubber material has at least one different property than a second region 18 adjacent to the first region 20, with the first region 20 and second region 18 cross-linked to one another. The curing, for example, causes a merging of two adjacent surfaces of uncured rubber material (e.g., at interface 52, 54 discussed herein) by cross-linking such that the adjacent surfaces no longer exist. For example, in the case of initially separate layers of uncured rubber, the layers become joined together by cross-linking to form a structure that is both unitary and monolithic.

The rubber layers 16, 18, and 20 are stacked in a direction from the proximal side 30 to the distal side 32. In the embodiment of the monolithic component 14 shown herein, all three of the rubber layers 16, 18, and 20 are exposed at the distal side 32, as is evident in FIG. 7, and have at least one different property as discussed herein.

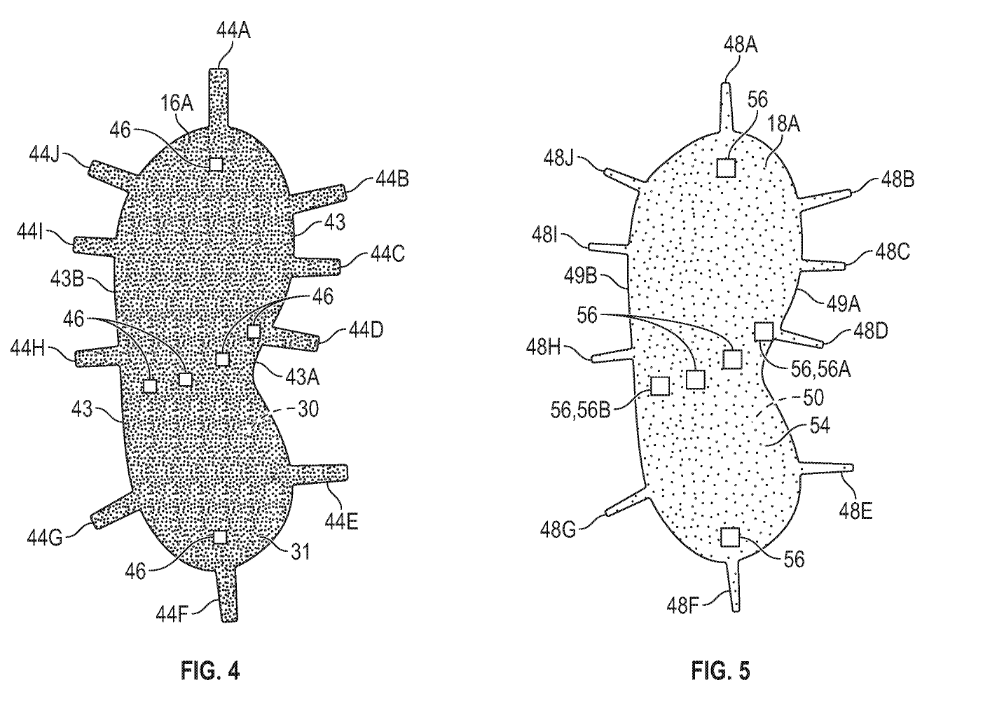

FIG. 2 is a plan view of an uncured rubber sheet 40 on a backing layer 42. The backing layer 42 may have a sticky surface for maintaining the uncured rubber sheet 40 in position during a cutting process in which the uncured rubber sheet 40 is cut at a perimeter 43 and at various through holes 46 to provide the uncured rubber layer 16A of FIG. 3. The cutting process may be automated and computer-controlled, such as by using a digital cutting machine. In other implementations, the uncured rubber may be formed to result in the shapes shown in FIGS. 4-6 rather than cut.

As used herein “uncured” rubber is rubber that has an absence of cross-linking. The uncured rubber may be natural rubber, polyisoprene rubber, polybutadiene, uncured butyl rubber or any combination thereof. In some embodiments, each of the uncured rubber layers may include a curing agent. Curing of the rubber may be by but is not limited to vulcanization such as with heat, pressure, and sulfur, or by a peroxide cross-linking agent, for example. Due to the absence of cross-linking in the uncured rubber used for the uncured rubber layers 16A, 18A, and 20A, unused scraps cut from the original uncured rubber sheet (like sheet 40 of FIG. 2) when cutting the shape and any apertures or recesses in each of the uncured rubber layers 16A, 18A, and 20A may be more easily recycled as the uncured state of the scraps will allow their use in other implementations that include curing, whereas any scraps that included cross-linking would not be amenable to such uses.

FIG. 4 is a plan view of the uncured rubber layer 16A of FIG. 3 removed from the backing layer 42 after the cutting process. The cut, uncured rubber layer 16A includes a plurality of fingers 44A, 44B, 44C, 44D, 44E, 44F, 44G, 44H, 44I, and 44J. After cutting and once cured together with uncured rubber layers 18A and 20A discussed herein, the uncured rubber layer 16A will become the rubber layer 16 that is cross-linked to the adjacent rubber layer 18 at an interface 31, 50 as discussed herein. More specifically, a distal side 31 of the rubber layer 16 will be cross-linked to a proximal side 50 of the rubber layer 18 (indicated at the uncured second rubber layer 18A in FIG. 5), with the distal side 31 and the proximal side 50 defining the interface.

The fingers 44B, 44C, 44D, and 44E may be considered a plurality of medial fingers at a medial extent 43A of the uncured rubber layer 16A. The medial extent 43A includes the edges of the medial fingers 44B, 44C, 44D, and 44E and establishes (and may be referred to as) a medial edge of the uncured rubber layer 16A and, once cured, of the rubber layer 16. The fingers 44J, 44I, 44H, and 44G may be considered a plurality of lateral fingers at a lateral extent 43B of the uncured rubber layer 16A. The lateral extent 43B includes the edges of the lateral fingers 44J, 44I, 44H, and 44G and may establish and be referred to as a lateral edge of the uncured rubber layer 16A and, once cured, of the rubber layer 16.

FIG. 5 is a plan view of a cut, uncured rubber layer 18A for the sole structure of FIG. 1 which, once cured, will become the rubber layer 18 of FIG. 1. The rubber layer 18A may be cut from an uncured rubber sheet held on a sticky backing layer, like sticky backing layer 42, similar to the process for cutting the rubber layer 16A. The rubber sheet from which the rubber layer 18A is cut has at least one property that is different from the uncured rubber sheet from the rubber layer 16A is cut so that, once cured as part of the monolithic component 14, the rubber layer 16 and the rubber layer 18 will have at least one different property.

As used herein, a “property” of any of the rubber layers 16, 18, or 20 or any of the rubber layers of the other examples shown herein is measurable and/or observable, and may include but is not limited to a different material, color, transparency, or translucency, a different hardness, a different elastic modulus, a different thickness, or a different material or grade, or any combination of such differences.

For example, the rubber layer 20 may have a first hardness, the rubber layer 18 may have a second hardness different from the first hardness, and the rubber layer 16 may have a third hardness different than each of the first hardness and the second hardness (e.g., at least 5 percent less than or greater than the other hardnesses). Hardness may be quantified in any standard manner known to those skilled in the art, such as a Shore A Durometer measured using ASTM D2240-05(2010) standard test method or as an Asker C hardness measured using hardness test JIS K6767 (1976).

In some examples, the rubber layer 20 may have a first elasticity, the rubber layer 18 may have a second elasticity, and the rubber layer 16 may have a third elasticity where each elasticity is different (e.g., at least 5 percent less than or greater than the other elasticities). A lower hardness and/or a lower elastic modulus enables greater flexibility.

In an example, the rubber layer 20 may have a first color at the interface of the rubber layer 20 and the second rubber layer 18 (interface of distal side 54 and proximal side 52), the rubber layer 18 may have a second color at that interface of the distal side 54 and the proximal side 52 as well as at the interface of the proximal side 50 and the distal side 31), and the rubber layer 16 may have a third color at the interface of the rubber layer 18 and the rubber layer 18 (interface of distal side 31 and proximal side 50). In another example, one or more of the rubber layers 16, 18, 20 may be transparent or translucent while the remaining rubber layers have a color that may be the same color or a different color. Curing the rubber layers together after stacking may help to ensure a very distinct and crisp boundary between the colors at the interfaces.

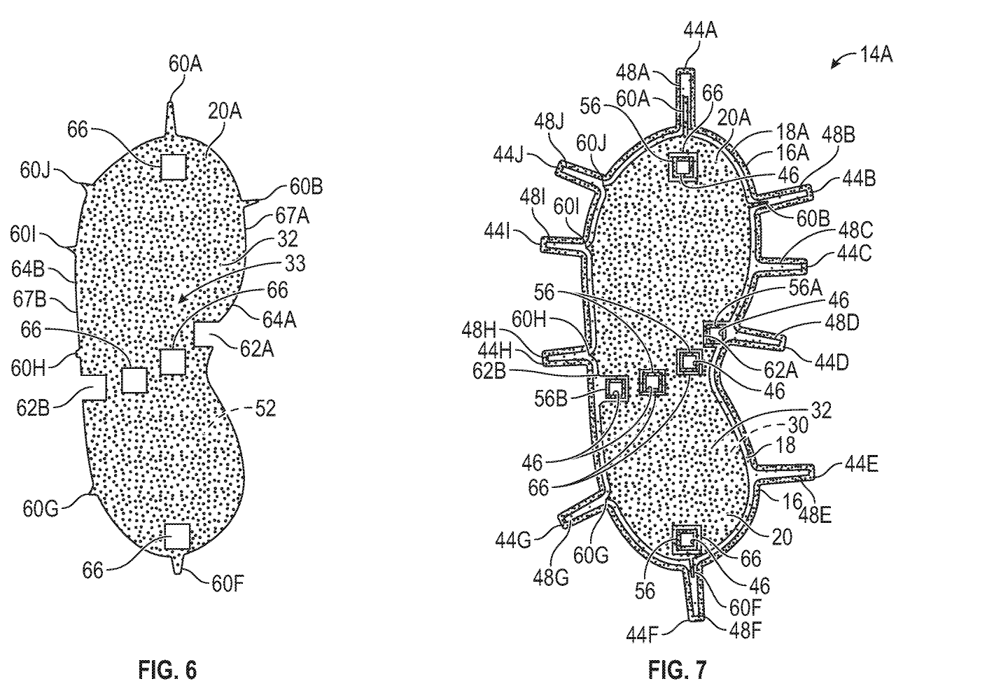

Referring to FIG. 5, the uncured rubber layer 18A is shown after a cutting process similar to that described with respect to the rubber layer 16A, and after removal from a similar sticky backing layer 42. The cut, uncured rubber layer 18A includes a plurality of fingers 48A, 48B, 48C, 48D, 48E, 48F, 48G, 48H, 48I, and 48J. After cutting and once cured together with uncured rubber layers 16A and 20A discussed herein, the uncured rubber layer 18A will become the second rubber layer 18 that is cross-linked to the adjacent rubber layer 16 at the interface of the distal side 31 of the rubber layer 16 and the proximal side 50 of the rubber layer 18 as discussed herein. More specifically, a distal side 31 of the rubber layer 16 will be cross-linked to a proximal side 50 of the rubber layer 18. Similarly the cured rubber layer 20 will be cross-linked to the adjacent rubber layer 18 at the interface of the proximal side 52 of the rubber layer 20 (see FIG. 6) and the distal side 54 of the rubber layer 18.

The fingers 48B, 48C, 48D, and 48E may be considered a plurality of medial fingers at a medial extent 49A of the uncured rubber layer 18A. The medial extent 49A includes the edges of the medial fingers 48B, 48C, 48D, and 48E and establishes (and may be referred to as) a medial edge of the uncured rubber layer 18A and, once cured, of the rubber layer 18. The fingers 48J, 48I, 48H, and 48G may be considered a plurality of lateral fingers at a lateral extent 49B of the uncured rubber layer 18A. The lateral extent 49B includes the edges of the lateral fingers 48J, 48I, 48H, and 48G and may establish and be referred to as a lateral edge of the uncured rubber layer 18A and, once cured, of the rubber layer 18.

Notably, the fingers 48A, 48B, 48C, 48D, 48E, 48F, 48G, 48H, 48I, and 48J align with and are stacked on the fingers 44A, 44B, 44C, 44D, 44E, 44F, 44G, 44H, 44I, and 44J, respectively, with each finger 48A, 48B, 48C, 48D, 48E, 48F, 48G, 48H, 48I, and 48J having a lesser width than the respective finger 44A, 44B, 44C, 44D, 44E, 44F, 44G, 44H, 44I, and 44J on which it is stacked such that a peripheral portion of each finger 44A, 44B, 44C, 44D, 44E, 44F, 44G, 44H, 44I, and 44J at the distal side 31 of the rubber layer 16 is exposed at the distal side 32 of the monolithic component 14 as shown in FIG. 7 and FIG. 1. The distal side 32 includes not only the ground contact surface 33, but the entirety of the exposed outer surfaces of the monolithic component 14 in the final assembled article of footwear 10.

The uncured rubber layer 18A is also cut with various through holes 56 in a pattern such that each of the through holes 56 aligns with a respective one of the through holes 46 when the rubber layers 16 and 18 are stacked together as shown in FIGS. 1 and 7. Each through hole 56 is larger than the respective through hole 46 with which it aligns such that a portion of the distal side 31 of the rubber layer 16 is exposed at the distal side 32 of the component 14A as shown in FIG. 7, where the component 14A is the stacked uncured rubber layers 16A, 18A, and 20A prior to curing as well as the distal side of the cured monolithic component 14.

Referring to FIG. 6, the uncured rubber layer 20A is shown after a cutting process similar to that described with respect to the uncured rubber layers 16A, 18A, and after removal from a similar sticky backing layer 42. The cut, uncured rubber layer 20A includes a plurality of fingers 60A, 60B, 60F, 60G, 60H, 60I, and 60J. The cut, uncured rubber layer 20A also includes notches 62A and 62B at a perimeter of the uncured rubber layer 20A.

After cutting and once cured together with uncured rubber layers 16A and 18A discussed herein, the uncured rubber layer 20A will become cross-linked to the adjacent rubber layer 18 at the interface of the proximal side 52 of the rubber layer 20 and the distal side 54 of the rubber layer 18. More specifically, a distal side 54 of the rubber layer 18 will be cross-linked to the proximal side 52 of the rubber layer 20.

The finger 60B may be considered a medial finger at a medial extent 67A of the uncured rubber layer 20A. The medial extent 67A includes the edges of the medial finger 60B as well as the notch 62A and establishes (and may be referred to as) a medial edge 64A of the uncured rubber layer 20A and, once cured, of the rubber layer 20. The fingers 60G, 60H, 60I, and 60J may be considered a plurality of lateral fingers at a lateral extent 67B of the uncured rubber layer 20A. The lateral extent 67B includes the edges of the lateral fingers 60G, 60H, 60I, and 60J as well as the notch 62B and may establish and be referred to as a lateral edge 64B of the uncured rubber layer 20A and, once cured, of the rubber layer 20.

Notably, the fingers 60A, 60B, 60F, 60G, 60H, 60I and 60J align with and are stacked on the fingers 48A, 48B, 48F, 48G, 48H, 48I, and 48J, respectively, with each finger 60A, 60B, 60F, 60G, 60H, 60I and 60J having a lesser width and shorter length than the respective finger 48A, 48B, 48F, 48G, 48H, 48I, and 48J on which it is stacked such that a peripheral portion of each finger 48A, 48B, 48F, 48G, 48H, 48I, and 48J is exposed at the distal side 32 of the monolithic component 14 as shown with respect to fingers 48A, 48B, 48C, 48D, 48E, and 48F in FIGS. 1 and 7, and as shown with respect to all of the fingers 48A, 48B, 48C, 48D, 48E, 48F, 48G, 48H, 48I, and 48J with respect to component 14A in FIG. 7.

The aligned fingers of the stacked rubber layers 16, 18, and 20 may provide greater flexibility in dorsiflexion in the cured monolithic component 14, for example, than would a monolithic component including layers that extend up the sides of the foam midsole layer 22 and onto the footwear upper 24 without any cuts or fingers at the medial and lateral extents.

The uncured rubber layer 20A is also cut with various through holes 66 and notches 62A, 62B in a pattern such that each of the through holes 66 aligns with a respective one of the through holes 56 and the notches 62A, 62B align with the through holes 56 labelled 56A and 56B, respectively, in FIG. 5 when the rubber layers 18 and 20 are stacked together as shown in FIGS. 1 and 7.

Each through hole 66 and notch 62A, 62B is larger than the respective through hole 56 with which it aligns such that a portion of the distal side 54 of the uncured rubber layer 18A is exposed at the distal side 32 of the component 14A as shown in FIG. 7. In fact, since all three of the uncured rubber layers have through holes that are aligned (e.g., through holes 46 of the first uncured rubber layer 16A are aligned with through holes 56 of the uncured rubber layer 18A and both through holes 46 and 56 are aligned with through holes 66 or notches 62A, 62B of the uncured rubber layer 20A), the aligned through holes create an opening extending entirely through the monolithic component 14 from the distal side 32 to the proximal side 30 such that the foam midsole layer 22 is exposed from the distal side 32 at the aligned through holes 46, 56, 66 and notches 62A, 62B.

Because they are exposed at the distal side 32, under certain compressive loads on the sole structure 12 and/or lateral movements when the article of footwear 10 is worn, at least two of the rubber layers 16, 18, and 20 or all three of the rubber layers 16, 18 and 20 may at least partially define a ground contact surface 33 of the sole structure 12 at the distal side 32. In other words, the ground contact surface 33 may include the distal side 32 of the rubber layer 20, portions of the distal side 54 of the rubber layer 18 around the through holes 56 that are exposed at the through holes 66 and notches 62A, 62B, and portions of the distal side 31 of the rubber layer 16 around the through holes 46 that are exposed at the aligned through holes 56 and 66.

In FIG. 7, the component 14A is shown after cutting and stacking and just prior to curing. The stacked, uncured rubber layers 16A, 18A, 20A are stacked in a direction from the proximal side 30 to the distal side 32 and maintain their relative placement due to the tacky nature of uncured rubber that will prevent shifting of adjacent layers at the interfaces (interface of distal side 31 and proximal side 50, and interface of distal side 54 and proximal side 52). The layers are stacked upon one another as shown in FIG. 7 without adhesive between adjacent ones of the multiple uncured rubber layers. In other words, no adhesive is placed on the distal side 31, or on the proximal side 50, or on the distal side 54 or on the proximal side 52. In other words, at least one of the multiple uncured rubber layers, such as the uncured rubber layer 18A (which is the middle layer and therefore interfaces with both the uncured rubber layer 16A and the uncured rubber layer 20A), may have a sufficiently soft durometer such that friction between the at least one of the multiple uncured rubber layers (uncured rubber layer 18A) and an adjacent one of the multiple uncured rubber layers (uncured rubber layer 16A and/or uncured rubber layer 20A) prevents shifting of the adjacent ones of the multiple uncured rubber layers 16A, 18A, and 20A after the stacking and prior to the curing.

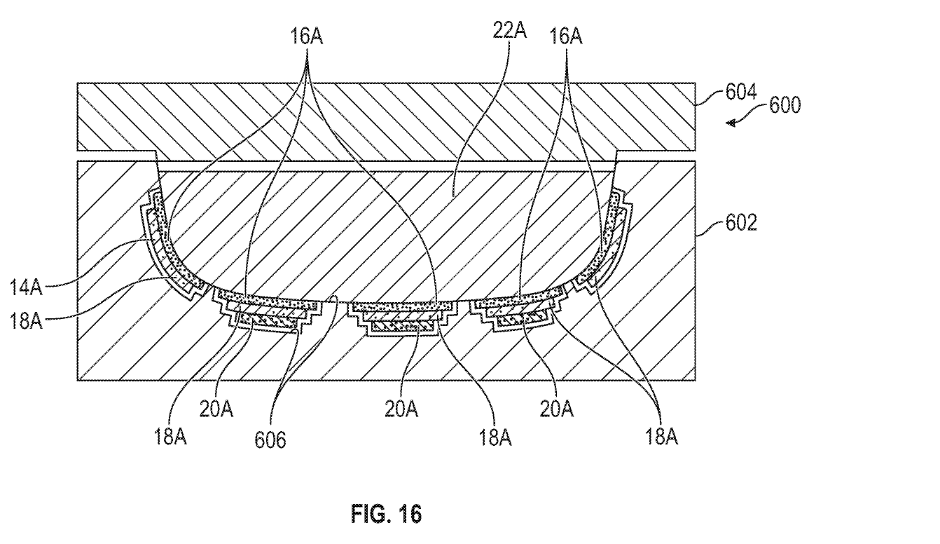

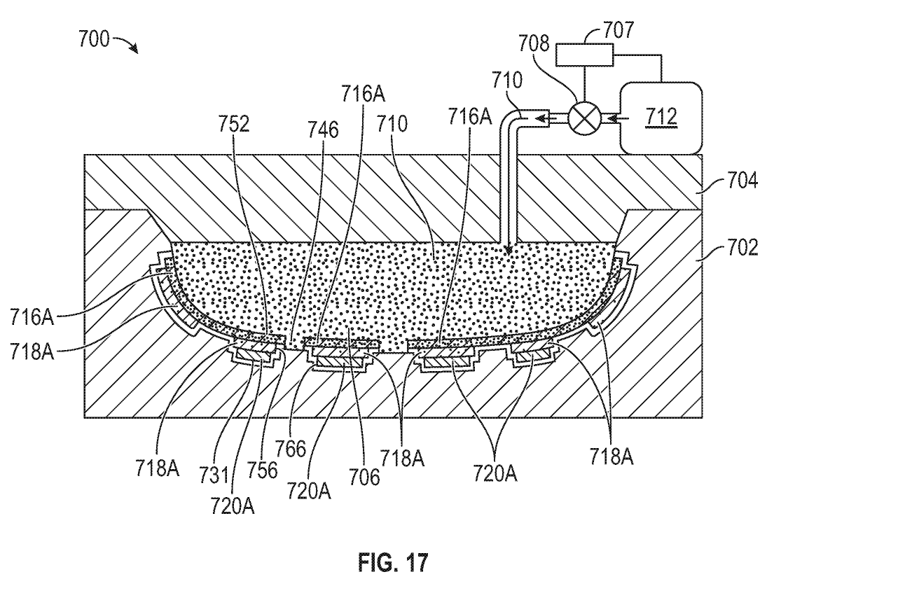

The stacked uncured rubber layers 16A, 18A, and 20A might be placed in a mold with a preform of the foam midsole layer 22 (similar to the process discussed with respect to FIG. 16), or foam might be injected into the mold to form the foam midsole layer 22 (which could be after curing the stacked uncured rubber layers 16A, 18A, 20A, similar to the process described with respect to FIG. 17), or adhesive might be placed on the proximal side 30 of the rubber layer 16 after curing and the stacked layers adhered to the foam midsole layer 22 after the stacked layers are cured.

In any of these processes, the monolithic component 14 will wrap upward onto and be secured to the foam midsole layer 22 and to the footwear upper 24 at the medial side 26 of the foam midsole layer 22 and the footwear upper 24 and at the lateral side 28 of the foam midsole layer 22 and the footwear upper 24. Specifically, the plurality of medial fingers 44B, 44C, 44D, and 44E are secured to the foam midsole layer 22 and the footwear upper 24 at the medial side 26 and the plurality of lateral fingers 44J, 44I, 44H and 44G are secured to the foam midsole layer 22 and the footwear upper 24 at the lateral side 28. The finger 44A is secured at a front of the forefoot region 10A of the foam midsole layer 22 and the footwear upper 24, and the finger 44F is secured at a rear of the heel region 10C of the foam midsole layer 22 and the footwear upper 24.

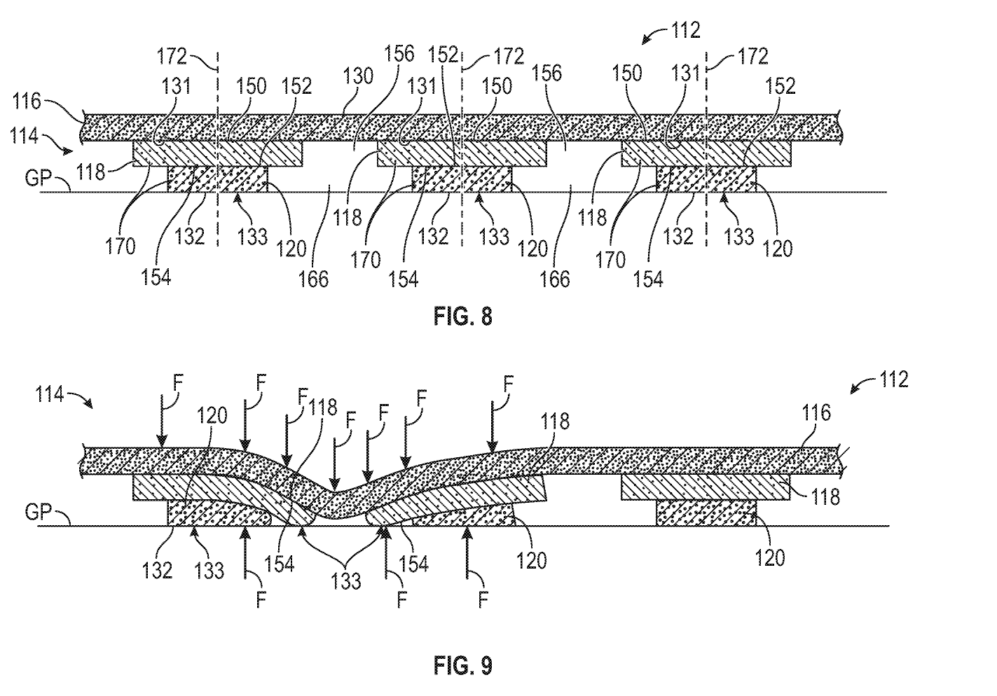

FIG. 8 is a fragmentary cross-sectional view of an example of a monolithic component 114 of a sole structure 112 including stacked, cured rubber layers (rubber layer 116, rubber layer 118, and rubber layer 120) shown resting on a ground plane GP. For purposes of the discussion herein, the rubber layer 120 may be referred to as the first rubber layer, the rubber layer 118 may be referred to as the second rubber layer, and the rubber layer 116 may be referred to as the third rubber layer. The monolithic component 114 is shown as an outsole. A midsole layer and a footwear upper included in the sole structure 112 are not shown.

The monolithic component 114 is manufactured as described with respect to the monolithic component 14 of FIGS. 1 and 7 in that adjacent rubber layers 116, 118, and 120 are first stacked together as uncured rubber layers and then cured to secure to one another with cross-linking and without adhesive as regions of the monolithic component 114 as a single unit of cured rubber.

Additionally, each of the rubber layers 116, 118, and 120 has at least one property different from the others, such as hardness, color, etc. For example, the first rubber layer 120 and the second rubber layer 118 meet at and define an interface 152, 154 (referred to as a first interface) where the proximal side 152 of the first rubber layer 120 meets the distal side 154 of the second rubber layer 118 and is crosslinked thereto. The second rubber layer 118 and the third rubber layer 116 meet at and define an interface 150, 131 (referred to as a second interface) where the proximal side 150 of the second rubber layer 118 meets the distal side 131 of the third rubber layer 116 and is crosslinked thereto. Although the interfaces between adjacent cured rubber layers are represented as solid lines in the figures for purposes of clarity, it should be appreciated that there are in fact no identifiable surfaces or boundaries between adjacent cured layers due to the cross-linking, as discussed herein.

The rubber layers 116, 118, and 120 may have different colors, or one or more may be transparent or translucent such that adjacent rubber layers have different colors, transparencies, or translucencies. For example, the first rubber layer 120 may have a first color at the first interface 152, 154, the second rubber layer 118 may have a second color at the first interface 152, 154 and at the second interface 150, 131, and the third rubber layer 116 may have a third color at the second interface 150, 131.

The rubber layers 116, 118, and 120 are stacked in a direction from the distal side 132 of the monolithic component 114 (distal side 132 of the rubber layer 120) to the proximal side 130 of the monolithic component 114 (proximal side 130 of the rubber layer 116) with the distal side 131 of the rubber layer 116 secured to the proximal side 150 of the rubber layer 118 by cross-linking and without adhesive at the interface 131, 150, and the proximal side 152 of the rubber layer 120 secured to the distal side 154 of the rubber layer 118 at the interface 152, 154 by cross-linking an without adhesive.

The portion of the third rubber layer 116 shown in the cross-section of FIG. 8 has no through holes or recesses. However, the second rubber layer 118 has spaces 156 that are aligned with spaces 166 of the rubber layer 116. With this configuration, the second rubber layer 118 and the first rubber layer 120 define protrusions 170 at the distal side 132. As used herein, a protrusion extends in a Z direction (e.g., downward) when an article of footwear is resting on the ground plane GP and is not subjected to dynamic compressive forces or shear forces as discussed below.

Each protrusion 170 includes a portion of the rubber layer 120 and a portion of the rubber layer 118. In the example shown, the third rubber layer 116 does not form any portion of the protrusion but, in other examples, there could be recesses at the distal side 131 of the third rubber layer 116 aligned with the spaces 156 such that the third rubber layer 116 also forms and is exposed along the length of the protrusions 170.

In an example, the spaces 156 and 166 may be through holes. In another example, instead of through holes, the spaces 156 and 166 may be sipes. In still another example, discrete (nonintegral) sections of the second rubber layer 118 may be stacked against the third rubber layer 116, and discrete (nonintegral) portions of the first rubber layer 120 may be stacked on the discrete sections of the second rubber layer 118, creating the spaces 156, 166 between the discrete sections and defining the protrusions 170.

As shown, all of the rubber layers 116, 118, and 120 are exposed at the distal side 132 of the monolithic component 114. In the embodiment shown, for each protrusion 170, the first rubber layer 120 is disposed as an outermost portion of the protrusion 170 along a vertical axis 172 of the protrusion 170. The vertical axis 172 of the protrusion 170 may also be referred to as an axis along the length of the protrusion 170 or a longitudinal axis of the protrusion 170. The second rubber layer 118 is exposed along the protrusion 170 proximal to the first rubber layer 120.

In FIG. 8, when the monolithic component 114 is simply resting on the ground plane GP and not subjected to dynamic compressive forces (e.g., forces parallel with or along the vertical axes 172) or to any shear forces (e.g., forces having a component perpendicular to the vertical axis 172 of the protrusions 170), the first rubber layer 120 will establish the entire ground contact surface 133 of the monolithic component 114. Stated differently, only the first rubber layer 120 is in contact with the ground plane GP under such conditions.

With reference to FIG. 9, under a compressive load of at least a threshold magnitude, as represented by forces F, the protrusions 170 compress such that the distal side 154 of the second rubber layer 118 also establishes a portion of the ground contact surface 133 of the monolithic component 114 along with the first rubber layer 120. Under even greater compressive forces and/or under a shear force, the third rubber layer 116 could even establish part of the ground contact surface 133 along with the other rubber layers 118 and 120. FIG. 9 shows the rubber layers 116, 118, and 120 deforming under the compressive load, but the layers do not separate from one another due to the cross-linking. Accordingly, by exposing the second rubber layer 118 and the third rubber layer 116 at the distal side 132, these layers 118 and 116 may become part of the ground contact surface 133 along with the first rubber layer 120 under certain conditions. Because each of the rubber layers 116, 118, and 120 has at least one property different than the each of other rubber layers (e.g., than one another), the performance of the monolithic component 114 may be different under different loading conditions.

For example, the first rubber layer 120 may have a first hardness and the second rubber layer 118 may have a second hardness. The first hardness of the first rubber layer 120 may be harder in order to provide the greatest durability and abrasion resistance for the monolithic component 114 because the first rubber layer 120 establishes at least a portion of the ground contact surface 133 under most or all use conditions. The second hardness of the second rubber layer 118 may be lesser (e.g., the second rubber layer 118 may be softer), creating greater friction with the ground surface GS when in contact therewith. This may aid in providing resistance to lateral slippage under shear forces, for example, when the second rubber layer 118 also establishes part of the ground contact surface 133.

The third rubber layer 116 may have a third hardness that is different than both the first hardness and the second hardness. In still another example, the first rubber layer 120 may be the softest and the third rubber layer 116 may be the hardest, with the second rubber layer 118 having a hardness between that of the first rubber layer 120 and the third rubber layer 116 so that, if the monolithic component 114 is completely worn through, the first rubber layer 120 and the second rubber layer 118, the third rubber layer 116 will become the ground contact surface 133 and will provide durability and abrasion resistance.

As shown, the outermost one of the layers or regions (first rubber layer 120) has a lesser fore-aft expanse and/or a lesser transverse expanse than an adjacent and more proximal one of the layers or regions (e.g., second rubber layer 118) such that both the outermost one of the layers or regions and the more proximal one of the layers or regions will be exposed at the distal side of an article of footwear that has the sole structure 114.

The cross-section in FIG. 8 is taken along a vertical plane and through the sole structure 114 with the sole structure 114 resting on the ground plane GP and with the distal-most one of the layers or regions (first rubber layer 120) forming at least a portion of the ground contact surface 133. As shown, a more proximal one of the layers or regions (e.g., second rubber layer 118) of the sole structure 114 has a greater width along an X-Y plane than the more distal first rubber layer 120. The same is true with respect to the most proximal one of the layers or regions (e.g., third rubber layer 116), which has a greater width along an X-Y plane than the more distal second rubber layer 118 and the distal-most first rubber layer 120.

The protrusions 170 at the distal side of the sole structure 114 form a topography of the sole structure 114 when the sole structure 114 rests on the ground plane GP with the distal-most one of the layers or regions 120 forming at least a portion of the ground contact surface 133. In such an orientation, a lower surface of a more proximal one of the layers or regions (e.g., second rubber layer 118 and/or third rubber layer 116) is exposed at and forms a portion of the distal side or ground-facing surface of the sole structure 114 around the more distal one of the layers or regions (e.g., first rubber layer 120). Stated differently, the distal side or ground-facing surface of the sole structure 114 includes at least the distal-most one of the layers or regions (e.g., first rubber layer 120) and a more proximal one of the layers or regions (e.g., second rubber layer 118 and/or third rubber layer 116).

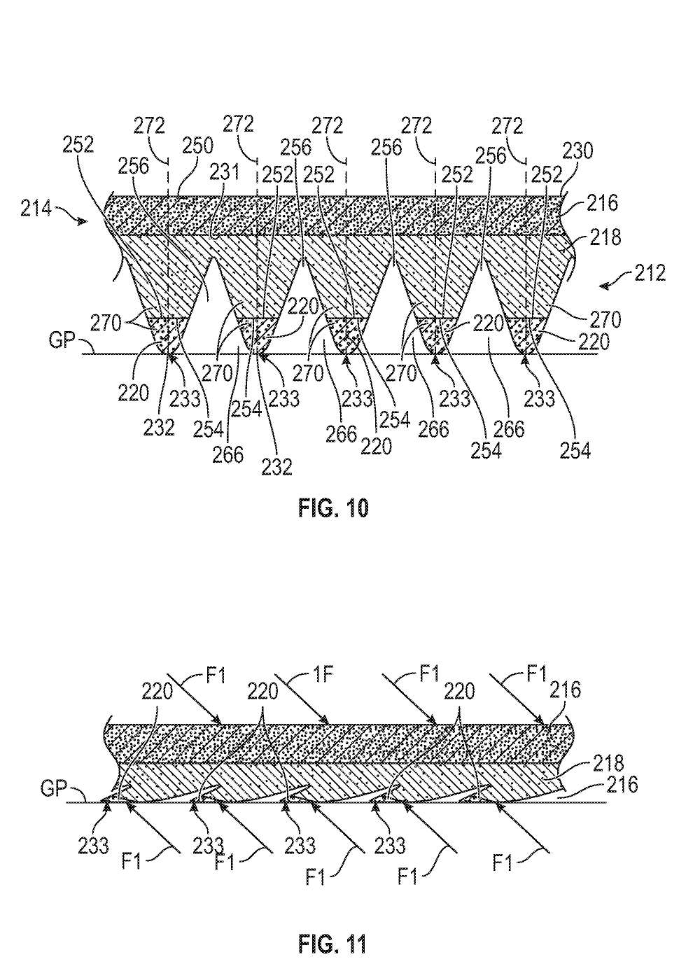

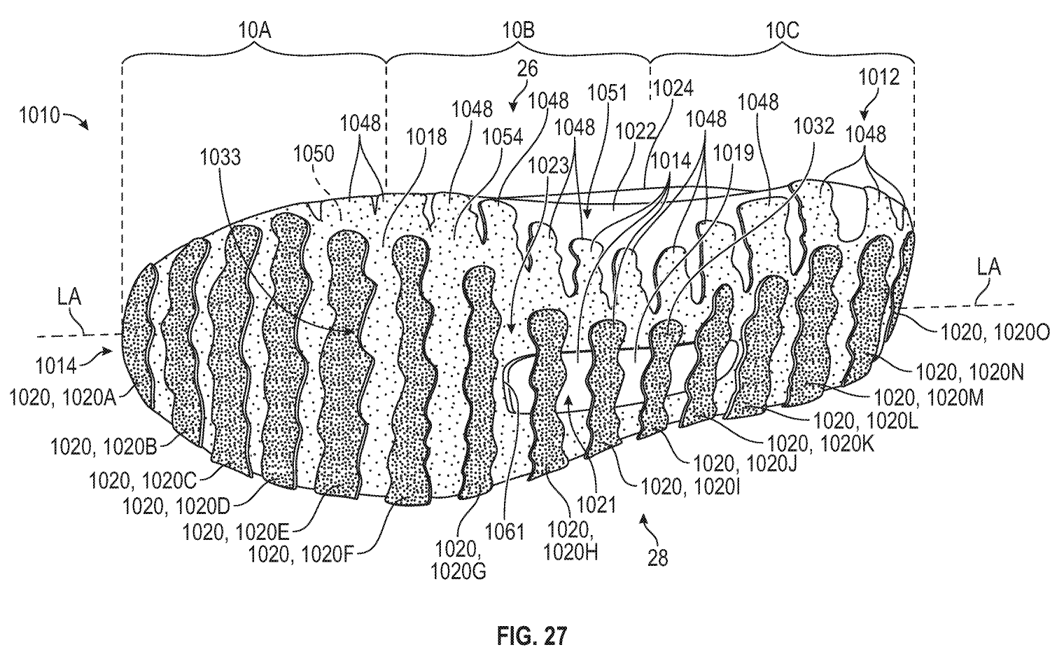

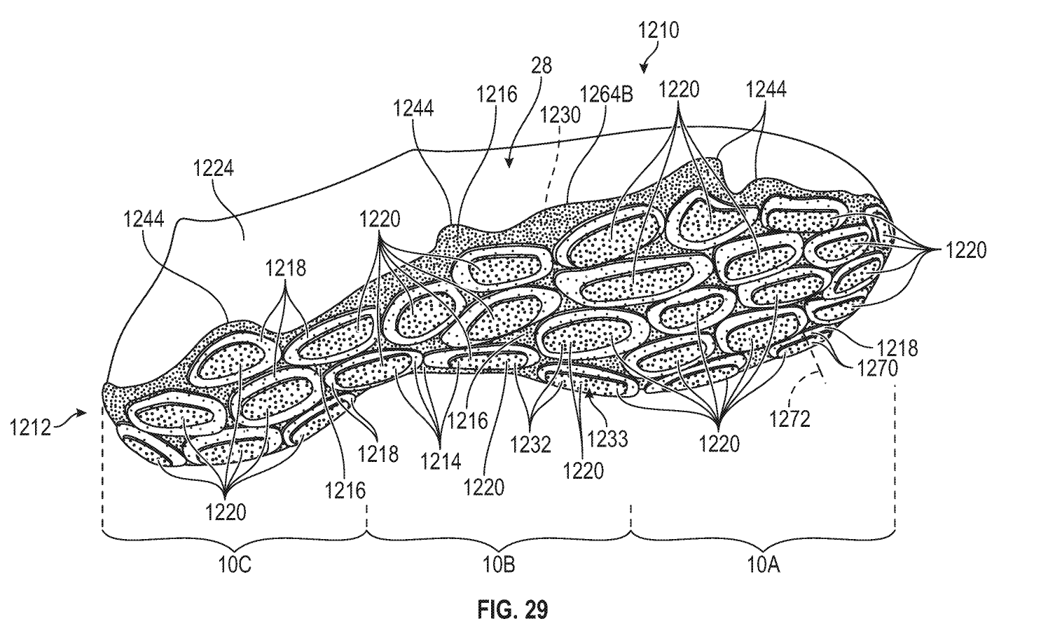

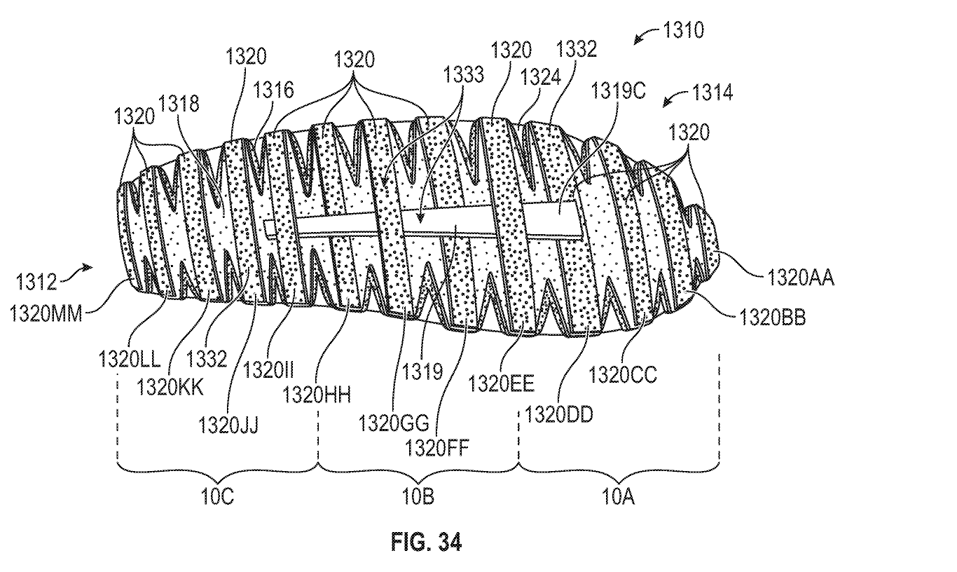

The protrusions 170 as discussed herein that include both the outermost one of the layers or regions (e.g., first rubber layer 120) and a more proximal one of the layers or regions (e.g., second rubber layer 118 and third rubber layer 116) exposed at the distal side or ground-facing surface of the article of footwear incorporating the sole structure 114 have a staggered, conical shape. Other protrusions shown and discussed herein have a variety of other shapes including, but not limited to, a rounded or conical shape (such as protrusions 270 in FIG. 10 and/or protrusions 1270 in FIG. 29), or a more extended ridge-like shape such as at regions 1320 and 1318 stacked on region 1316 in FIG. 34 to form linear ridges extending mainly in the transverse direction of the sole structure 1312, and as at regions 1020 stacked on region 1018 in FIG. 27 to form curvilinear ridges that extend both fore-aft and transversely at the distal side or ground-facing surface 1023 of the sole structure 1012.

FIG. 10 is a fragmentary cross-sectional view of another example of a monolithic component 214 of a sole structure 212 including stacked, cured rubber layers 216, 218, 220 and shown resting on a ground plane GP. The monolithic component 214 is shown as an outsole. For purposes of the discussion herein, the rubber layer 220 may be referred to as the first rubber layer, the rubber layer 218 may be referred to as the second rubber layer, and the rubber layer 216 may be referred to as the third rubber layer. A midsole layer and a footwear upper included in the sole structure 212 are not shown.

The monolithic component 214 is manufactured as described with respect to the monolithic component 14 of FIG. 1 in that adjacent rubber layers 216, 218, and 220 are first stacked together as uncured rubber layers and then cured to secure to one another with cross-linking and without adhesive as regions of the monolithic component 214 as a single unit of cured rubber.

Additionally, each of the rubber layers 216, 218, and 220 has at least one property different from the others, such as hardness, color, etc. For example, the first rubber layer 220 and the second rubber layer 218 meet at and define an interface 252, 254 (referred to as a first interface) where the proximal side 252 of the first rubber layer 220 meets the distal side 254 of the second rubber layer 218.

The second rubber layer 218 and the third rubber layer 216 meet at and define an interface 250, 231 (referred to as a second interface) where the proximal side 250 of the second rubber layer 218 meets the distal side 231 of the third rubber layer 216. The rubber layers 216, 218, and 220 may have different colors, or one or more may be transparent or translucent such that adjacent rubber layers have different colors, transparencies, or translucencies. For example, the first rubber layer 220 may have a first color at the first interface 252, 254, the second rubber layer 218 may have a second color at the first interface 252, 254 and at the second interface 250, 231, and the third rubber layer 216 may have a third color at the second interface 250, 231.

The rubber layers 216, 218, and 220 are stacked in a direction from the distal side 232 of the monolithic component 214 (distal side 232 of the rubber layer 220) to the proximal side 230 of the monolithic component 214 (proximal side 230 of the rubber layer 216) with the distal side 231 of the rubber layer 216 secured to the proximal side 250 of the rubber layer 218 by cross-linking and without adhesive at an interface 231, 250, and the proximal side 252 of the rubber layer 220 secured to the distal side 254 of the rubber layer 218 at an interface 252, 254 by cross-linking and without adhesive. It is noted that the distal side 232 of the first rubber layer 220 is a pointed tip of each of the protrusions 270 discussed herein.

The portion of the rubber layer 216 shown in the cross-section of FIG. 10 has no through holes or recesses. However, the rubber layer 218 has recesses 256 that are aligned with spaces 266 of the rubber layer 220. With this configuration, the rubber layer 218 and the rubber layer 220 define protrusions 270 at the distal side 232. Each protrusion 270 includes a portion of the rubber layer 220 and a portion of the rubber layer 218. In the example shown, the third rubber layer 216 does not form any portion of the protrusions 270. In an example, the spaces 266 may be through holes. In another example, the recesses 256 and spaces 266 are sipes. In still another example, discrete (nonintegral) sections of the rubber layer 220 may be stacked on the rubber layer 218, creating the spaces 266 aligned with the recesses 256 and defining the protrusions 270.

As shown, the rubber layers 218 and 220 are exposed at the distal side 232 of the monolithic component 214 and the rubber layer 216 is not exposed at the distal side 232. In the embodiment shown, for each protrusion 270, the first rubber layer 220 is disposed as an outermost portion of the protrusion 270 along a vertical axis 272 of the protrusion 270. The vertical axis 272 of the protrusion 270 may also be referred to as an axis along the length of the protrusion 270 or a longitudinal axis of the protrusion 270. The second rubber layer 218 is exposed along the protrusion 270 proximal to the first rubber layer 220.

In FIG. 10, when the monolithic component 214 is simply resting on the ground plane GP and not subjected to significant dynamic compressive forces (e.g., forces parallel with or along the vertical axes 272 of at least a threshold magnitude) or to any significant shear forces (e.g., forces having a component greater than a threshold magnitude that is perpendicular to the vertical axis 272 of the protrusions 270), the first rubber layer 220 will establish the entire ground contact surface 233 of the monolithic component 214. Stated differently, only the first rubber layer 220 is in contact with the ground plane GP under such conditions.

With reference to FIG. 11, under a compressive load of at least a threshold magnitude, as represented by forces F1 (which have both a compressive component and a shear component), the protrusions 270 compress such that a portion of the second rubber layer 218 also establishes a portion of the ground contact surface 233 of the monolithic component 214 along with the first rubber layer 220. Accordingly, by exposing the second rubber layer 218 at the distal side 232, the second layer 218 may become part of the ground contact surface 233 along with the first rubber layer 220. Because each of the rubber layers 216, 218, and 220 has at least one property different than the other rubber layers (e.g., than one another), the performance of the monolithic component 214 may be different under different loading conditions as discussed with respect to the monolithic component 114.

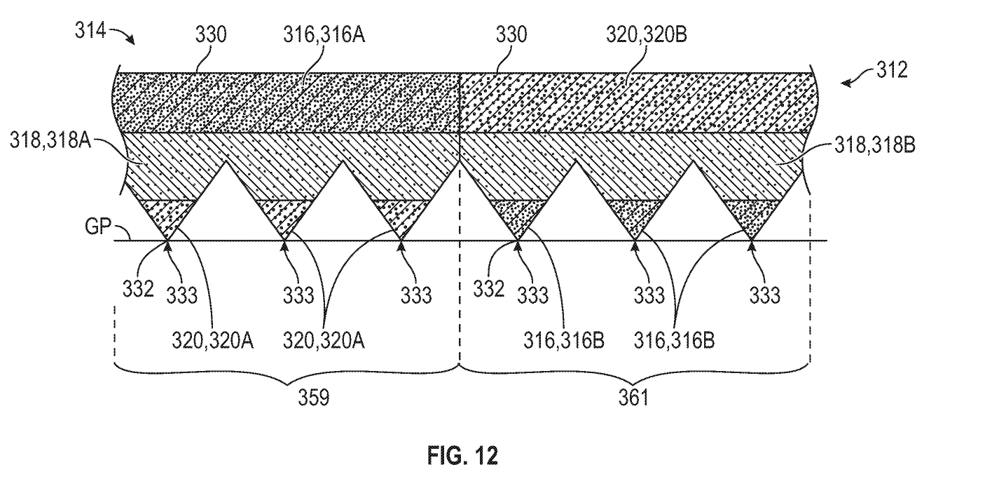

FIG. 12 is a fragmentary cross-sectional view of another example of a monolithic component 314 of a sole structure 312 including stacked, cured rubber layers 316, 318, and 320 and shown resting on a ground plane GP.

A first rubber layer 320 has discrete, discontinuous sections 320A and 320B, each having the same hardness and color, for example as they are cut from the same rubber sheet. The sections 320A are in a first region 359 of the sole structure 312 and in an article of footwear in which the sole structure 312 is incorporated (any of the articles of footwear shown herein), and the section 320B is in a second region 361 of the sole structure 312 and the article of footwear in which the sole structure 312 is incorporated. The region 359 may be a forefoot region, a midfoot region, or a heel region, or a portion thereof, such as forefoot region 10A, midfoot region 10B, or heel region 10C in FIG. 1, and the region 361 is a region adjacent thereto.

A second rubber layer 318 has discrete, discontinuous sections 318A and 318B, each having the same hardness and color, for example as they are cut from the same rubber sheet, but possibly a different hardness and/or color than the sections 320A, 320B of the first rubber layer 320. The third rubber layer 316 has discrete, discontinuous sections 316A, 316B, each having the same hardness and color, for example as they are cut from the same rubber sheet, but possibly a different hardness and/or color than the sections 320A, 320B of the first rubber layer 320 and than the sections 318A, 318B of the second rubber layer 318.

The sections of the rubber layers 316, 318, and 320 are stacked in a different order relative to one another in the first region 359 than in the second region 361. More specifically, the sections 320A of the first rubber layer 320 are nearest to the ground plane GP at the distal side 332 of the monolithic component 314 and establish the ground contact surface 333 in the first region 359 while the section 316A of the third rubber layer 316 establishes the proximal side 330 of the monolithic component 314 in the first region 359. In the second region 361, however, the section 316B of the third rubber layer 316 are nearest to the ground plane GP at the distal side 332 and establish the ground contact surface 333 in the second region 361 while the second section 320B of the first rubber layer 320 establishes the proximal side 330 in the second region 361. In this manner, different physical properties or different design aspects of the rubber layers 316, 318, and 320 may be utilized in correlation with the different regions 359, 361.

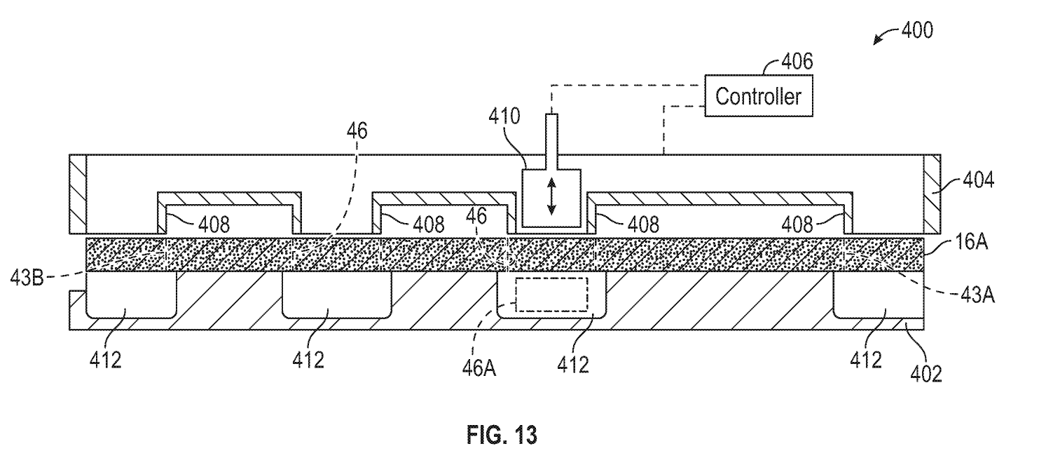

FIG. 13 is a cross-sectional view of a cutting machine 400 showing an uncured rubber layer 16A for any of the sole structures herein in the process of being cut. For purposes of discussion, the uncured rubber layer 16A is shown at a cross-section through an area at which two through holes 46 will be cut. The cutting machine 400 includes a base 402 on which the uncured rubber layer 16A is supported as well as a cutting tool 404 movable up and down in FIG. 13 relative to the base 402 under the control of an electronic controller 406.

Projections 408 of the cutting tool 404 are spaced and configured to cut the uncured rubber layer 16A to establish a medial extent 43A and a lateral extent 43B of the cut uncured rubber layer 16A, including cutting the various fingers 44A-44J and through holes 46 of FIG. 4. A movable foam die 410 is controlled by the electronic controller 406 to move down upon the uncured rubber layer within spaces between the projections 408 to eject the cut pieces of the uncured rubber layer 16A into cavities 412 of the base 402 so that the scrap pieces of uncured rubber are easily collected for recycling. One such scrap piece 46A is shown in phantom in FIG. 13.

FIG. 13 illustrates the cutting of uncured rubber layer 16A occurring prior to stacking the uncured rubber layers 16A, 18A, 20A. In an implementation in which the uncured rubber layers are stacked prior to cutting, a series of cutting tools having different shaped projections would be used for cutting the stacked layers subsequently from smallest to largest through holes, with the cutting tools for the relatively large through holes controlled to extending only through the stacked layers having through holes at least as large as those created by the cutting tool.

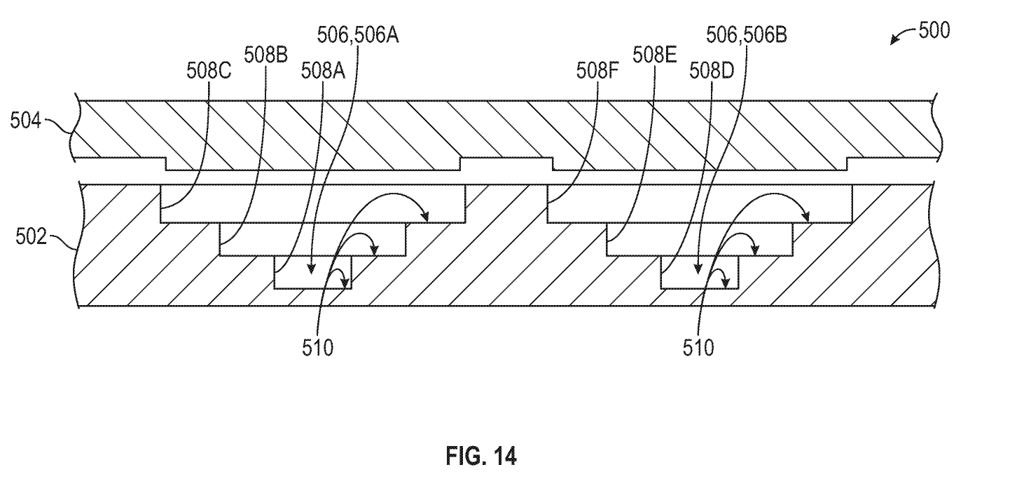

FIG. 14 is a fragmentary cross-sectional view of a mold 500 having a first mold portion 502 and a second mold portion 504. The first mold portion 502 has a mold cavity 506 including recesses 506A and 506B for registering multiple uncured rubber layers during stacking. As shown, the recess 506A has three recessed portions 508A, 508B, and 508C of different depths and the recess 506B has three recessed portions 508D, 508E, and 508F of different depths.

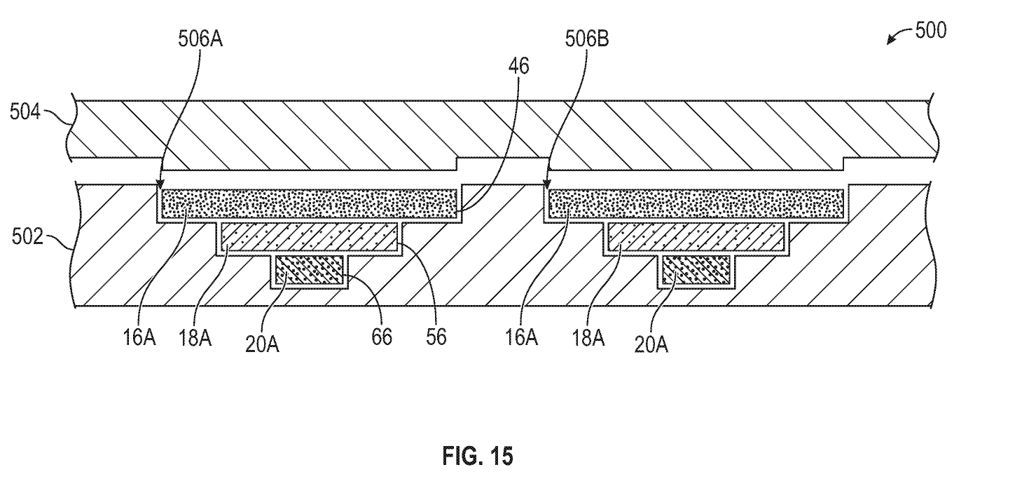

As such, the recesses 506A and 506B are tiered for supporting the multiple stacked uncured rubber layers after cutting of the layers and registering the layers relative to one another. For example, FIG. 15 is a fragmentary cross-sectional view of the mold 500 of FIG. 14 showing the multiple uncured rubber layers 16A, 18A, and 20A stacked in the recesses 506A and 506B. The portion of the uncured cut rubber layers 16A, 18A, and 20A shown in the fragmentary view of FIG. 15 is a portion that will result in aligned through holes 46, 56, and 66 between the two recesses 506A, 506B, for example.

The third uncured rubber layer 20A is registered in the mold 500 at the mold cavity 506 first, then the second uncured rubber layer 18A is registered in the mold 500 at the mold cavity 506 and stacked on the third uncured rubber layer 20A at the recesses 506A, 506B, and then the first uncured rubber layer 16A is registered in the mold 500 at the mold cavity 506 and stacked on the second uncured rubber layer 18A at the recesses 506A, 506B.

The stacked uncured rubber layers 16A, 18A, and 20A may then be cured in the mold 500 by moving the second mold portion 504 against the first mold portion 502 with sufficient pressure and heating the mold to a sufficient temperature to cure the stacked rubber layers 16, 18, 20, resulting in the cross-linking of adjacent rubber layers 16, 18, and 20 to one another at the interfaces as discussed herein. Accordingly the mold 500 sufficiently registers the stacked uncured rubber layers 16A, 18A, and 20A prior to curing to result in desired relative placement of the cured rubber layers 16, 18, 20 and resulting exposure of portions of each at the distal side 32 as discussed with respect to FIGS. 1 and 7.

In some implementations, the surface 510 of the mold 500 at the recesses 506A, 506B or portions of the surface 510 may be textured to impart a texture on the rubber layers 16A, 18A, and/or 20A that is in contact with the textured surface 510. For example, the surface 510 may impart a traction pattern on one or more of the rubber layers 16A, 18A, and/or 20A.

FIG. 16 is a cross-sectional view of a mold 600 showing the component 14A of FIG. 7 prior to curing the uncured rubber layers 16A, 18A, and 20A. For example, the uncured rubber layers 16A, 18A, and 20A are registered in the mold cavity 606 of a first mold portion 602. A midsole preform 22A is placed in the mold cavity 606 against the component 14A. The mold 600 is closed by placing the second mold portion 604 against the first mold portion 602 and pressure and heat are applied to cure the stacked rubber layers 16, 18, and 20, so that the midsole preform 22A forms the foam midsole layer 22, and so that the monolithic component 14 thermally bonds to the foam midsole layer 22 at the proximal side of the cured rubber layer 16. In an alternative embodiment, the rubber layers 16, 18, and 20 may have already been partly or wholly cured prior to placing in a mold with the midsole preform 22A.

FIG. 17 is a cross-sectional view of a mold 700 having a first mold portion 702 and a second mold portion 704, and showing multiple rubber layers 716A, 718A, and 720A registered to the first mold portion 702. The rubber layers 716A, 718A, and 720A are cured after being registered to define a monolithic component, and include a first rubber layer 720A, a second rubber layer 718A and a third rubber layer 716A, each having at least one property different than one another.

Prior to curing, the multiple rubber layers 716A, 718A, and 720A may be as described with respect to uncured rubber layers 16A, 18A, and 20A, respectively, except may be cut in a different pattern than the corresponding uncured rubber layers 16A, 18A, and 20A. In another example, the injected foam might be cured simultaneously with the curing of the rubber layers 716A, 718A, and 720A at a relatively low temperature, such as if a polyurethane foam is used.

After the rubber layers 716A, 718A, and 720A are cured, an electronic controller 707 is operable to open a valve 708 that causes stored foam 710, such as liquid foam or pellets, to be injected from a supply 712 into the mold cavity 706 of the mold portion 702 above the stacked rubber layers 716A, 718A, and 720A. The electronic controller 707 also controls the pressure and temperature in the mold 700 to cause the injected liquid foam or pellets to form a foam midsole layer.

In the example shown, prior to curing, the rubber layers 716A, 718A, and 720A are cut and stacked to define at least partially aligned through holes 746, 756, and 766 extending through the monolithic component from the proximal side 752 to the distal side 731. With such an example, the injected foam 710 fills the aligned through holes to the extent permitted by the contours of the mold cavity 706 (through 746 and partly through 756) and extends at least partially through at least some of the at least partially aligned through holes 746, 756, and 766 toward the distal side 731. The resulting foam midsole layer is thus exposed from the distal side 731 at the aligned through holes 746, 756, and 766.

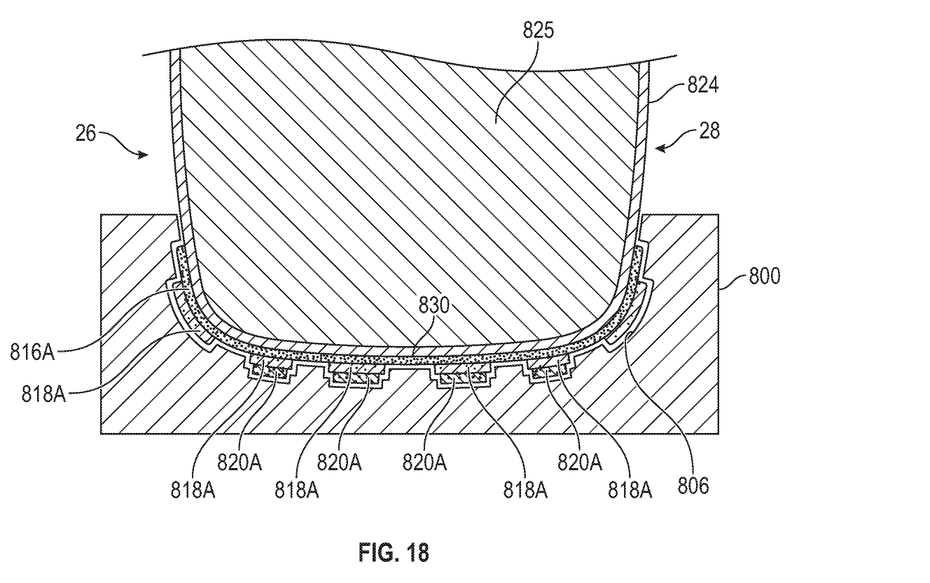

FIG. 18 is a cross-sectional view of a mold 800 showing multiple uncured rubber layers 816A, 818A, and 820A registered to the mold 800 and showing a fragmentary lasted footwear upper 824 positioned on a footwear last 825 and inserted into a mold cavity 806 of the mold 800 against the innermost stacked uncured rubber layer 816A (e.g., the uncured rubber layer 816A establishes a proximal side 830).

The multiple uncured rubber layers 816A, 818A, and 820A are shown registered to the mold 800. The multiple uncured rubber layers include a first uncured rubber layer 820A, a second uncured rubber layer 818A and a third uncured rubber layer 816A, each having at least one property different than one another. The multiple uncured rubber layers 816A, 818A, and 820A may be as described with respect to uncured rubber layers 16A, 18A, and 20A, respectively, except may be cut in a different pattern than the corresponding uncured rubber layers 16A, 18A, and 20A.

Once the lasted footwear upper 824 is placed against the stacked uncured rubber layers 816A, 818A, and 820A at the proximal side 830, the temperature and pressure in the mold 800 are controlled such that the uncured rubber layers 816A, 818A, and 820A cure to one another at adjacent interfaces as a monolithic component that thermally bonds to the footwear upper 824 during or after the curing.

In such an implementation, after removing the footwear upper 824 with the monolithic component of the cured rubber layers secured thereto from the mold 800 and from the footwear last 825, a drop-in midsole may be placed into a foot-receiving cavity of the footwear upper 824. For example, if the footwear upper 824 extends completely under the foot from the medial side 26 to the lateral side 28 (e.g., a sock-like upper) as shown in FIG. 18, then the drop-in midsole is provided within the footwear upper 824. A similar drop-in midsole 922A is shown in FIG. 26.

Accordingly, a method of manufacturing an article of footwear such as the article of footwear 10 of FIG. 1 may include selecting multiple uncured rubber sheets, each having at least one property different from the others, and then cutting uncured rubber layers from the multiple uncured rubber sheets. The method may include forming or cutting recesses or through holes in one or more of the uncured rubber layers. Next, the method may include stacking the uncured rubber layers on one another, and may include aligning through holes of the uncured rubber layers during the stacking, such as the through holes 46, 56, and 66 as discussed herein.

The method may then include placing the stacked rubber layers (in an uncured state or, in some embodiments, in an already cured state) into a mold, which may include registering one or more of the layers to the mold. A preform of a foam midsole layer or an already formed foam midsole layer may be placed in the mold, as described with respect to FIG. 16 such that the monolithic component thermally bonds to the foam midsole layer during or after the curing of the rubber layers. Alternatively, foam may be injected into the mold as in FIG. 17 to form the foam midsole layer such that the monolithic component thermally bonds to the form midsole layer during or after the curing. For example, the stacked rubber layers may be cured in the mold prior to injecting the foam. In other examples, the foam may be injected prior to curing the stacked rubber layers. In yet another alternative, in an embodiment like that of FIG. 18, a footwear upper may be placed in the mold prior to or after curing the monolithic component so that the monolithic component thermally bonds to the footwear upper.

A drop-in midsole may then be placed in a foot-receiving cavity of the footwear upper. Heat and pressure applied to the components in the mold will cure the adjacent rubber layers to one another as a monolithic component, creating cross-linking of the adjacent layers to one another, as well as securing the monolithic component to the midsole layer and/or to the footwear upper. No adhesive is used to secure the adjacent rubber layers to one another.

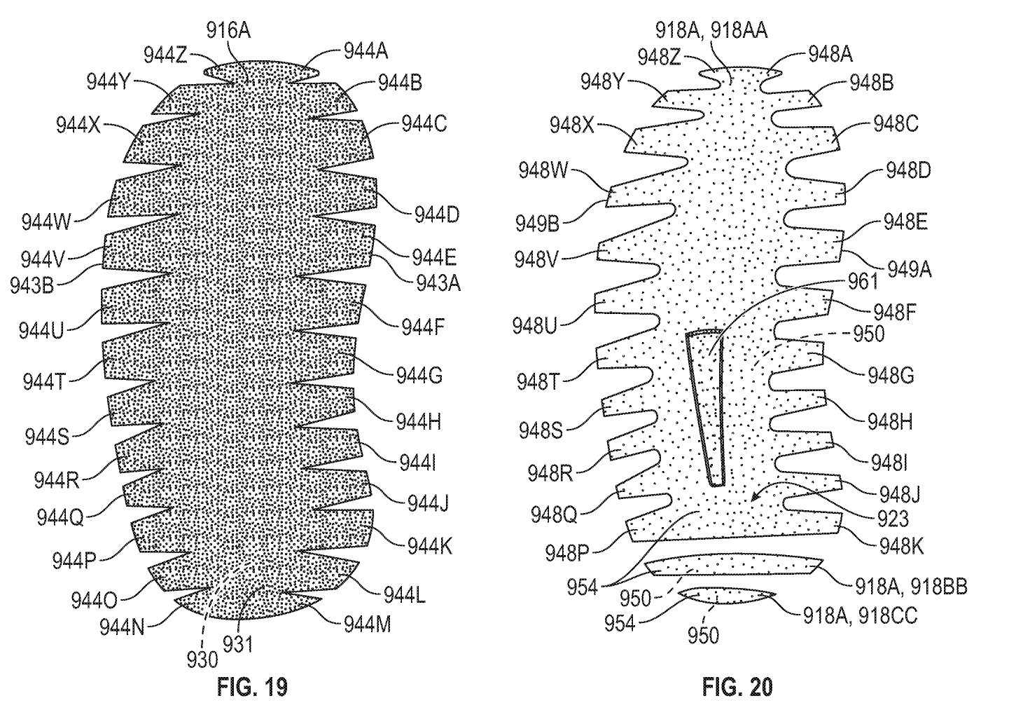

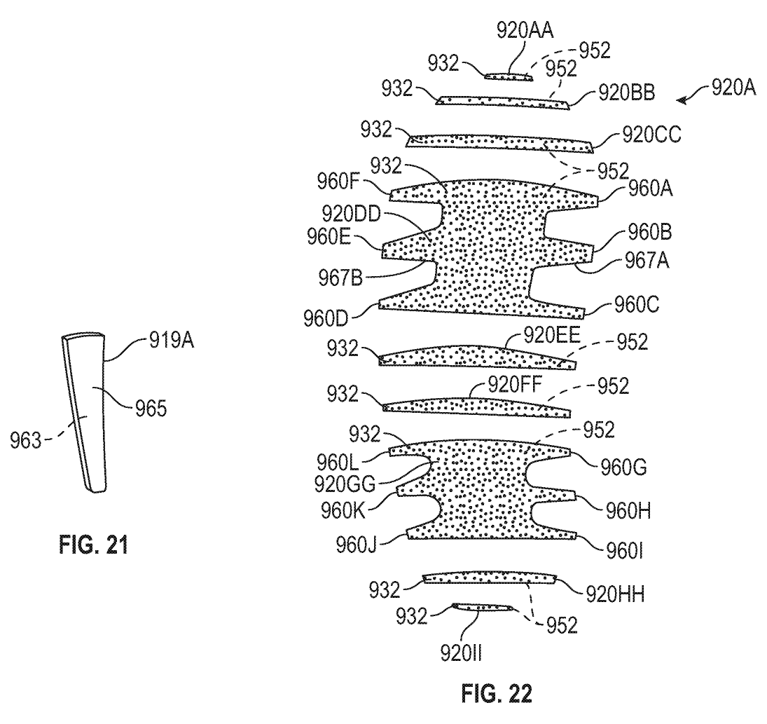

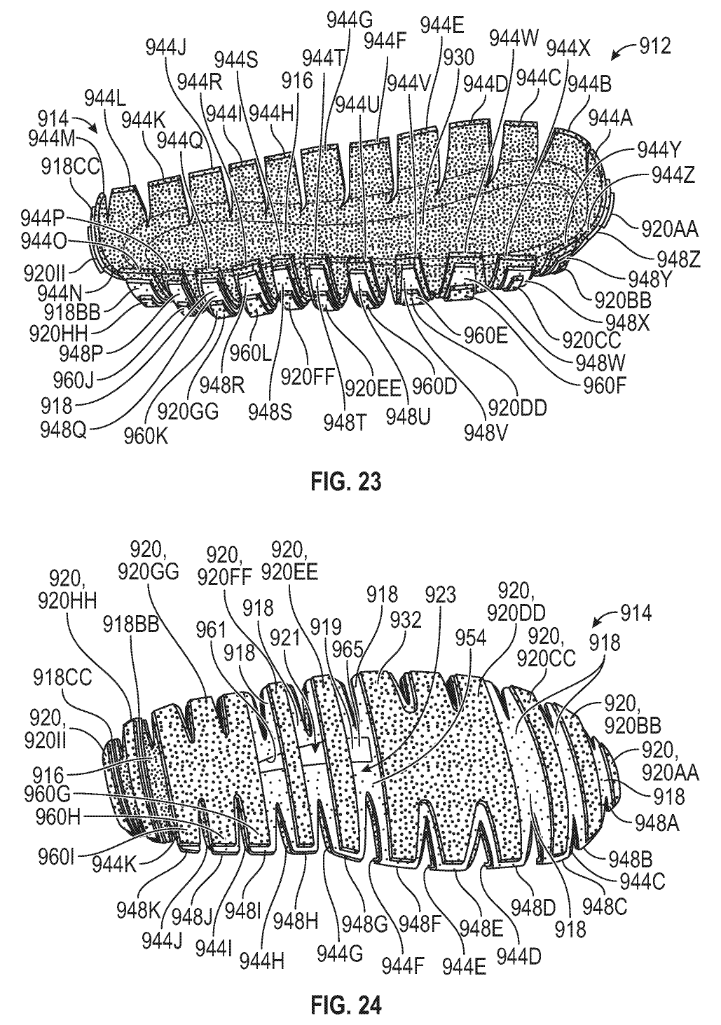

FIG. 19 is a plan view of a cut, uncured rubber layer 916A for the sole structure 912 of FIGS. 23-25 and for the sole structure 912A of FIG. 26. FIG. 20 is a plan view of another cut, uncured rubber layer 918A for the sole structures 912 and 912A. FIG. 21 is a plan view of another cut, uncured rubber layer 919A for the sole structures 912 and 912A. FIG. 22 is a plan view of another cut, uncured rubber layer 920A for the sole structures 912 and 912A. The uncured rubber layer 920A is cut into multiple discrete sections as discussed herein.

After cutting and once cured together with uncured rubber layers 918A, 919A, and 920A discussed herein, the uncured rubber layer 916A will become the rubber layer 916 that is cross-linked to the adjacent rubber layer 918 at an interface 931, 950 as discussed herein. More specifically, a distal side 931 of the rubber layer 916 will be cross-linked to a proximal side 950 of the cured rubber layer 918 (indicated at the uncured second rubber layer 918A in FIG. 20), with the distal side 931 and the proximal side 950 defining the interface. Similarly the cured rubber layer 920 will be cross-linked to the adjacent cured rubber layer 918 at the interface of the proximal side 952 of the rubber layer 920 and the distal side 954 of the cured rubber layer 918. The cured rubber layers may be referred to as a first rubber layer 920, a second rubber layer 918, and a third rubber layer 916. The rubber layer 919 may be referred to as an auxiliary rubber layer or as an additional rubber layer that will be cross-linked to the distal side 954 of the adjacent rubber layer 918 at a proximal side 963, and to the proximal side 952 of some of the discrete sections of the adjacent rubber layer 920 at the distal side 965.

At least the uncured rubber layers 916A, 918A, and 920A may each have at least one different property, such as hardness, color, etc., as discussed with respect to the uncured rubber layers 16A, 18A, and 20A for example. In other examples, only two of the uncured rubber layers 916A, 918A, and 920A need have a different property from one another. The uncured rubber layer 919A may have the same properties as any one of the other uncured rubber layers 916A, 918A, and 920A or a different property from each of the other uncured rubber layers 916A, 918A, and 920A.

FIG. 19 shows the cut, uncured rubber layer 916A includes a plurality of fingers 944A, 944B, 944C, 944D, 944E, 944F, 944G, 944H, 944I, 944J, 944K, 944L, 944M, 944N, 944O, 944P, 944Q, 944R, 944S, 944T, 944U, 944V, 944W, 944X, 944Y, and 944Z. The uncured rubber layer 916A may be cut from a rubber sheet held on a sticky backing layer, like sticky backing layer 42, similar to the process for cutting uncured rubber layer 16A. The fingers 944A-944M may be considered a plurality of medial fingers at a medial extent 943A of the uncured rubber layer 916A.

The medial extent 943A includes the edges of the medial fingers 944A-944M and establishes (and may be referred to as) a medial edge of the uncured rubber layer 916A and, once cured, of the rubber layer 916. The fingers 944N-944Z may be considered a plurality of lateral fingers at a lateral extent 943B of the uncured rubber layer 916A. The lateral extent 943B includes the edges of the lateral fingers 944J, 944I, 944H, and 944G and may establish and be referred to as a lateral edge of the uncured rubber layer 916A and, once cured, of the rubber layer 916.

FIG. 20 is a plan view of the cut, uncured rubber layer 918A for the sole structure 912, which, once cured, will become the rubber layer 918 of FIG. 23, for example. The rubber layer 918A may be cut from a rubber sheet held on a sticky backing layer, like sticky backing layer 42, similar to the process for cutting the uncured rubber layer 16A. Notably, the rubber layer 918A is cut in three discrete and discontinuous sections 918AA, 918BB, and 918CC.

Referring to FIG. 20, the uncured rubber layer 918A is shown after a cutting process similar to that described with respect to the rubber layer 16A, and after removal from a similar sticky backing layer 42. The section 918AA of the cut, uncured rubber layer 918A includes a plurality of fingers 948A, 948B, 948C, 948D, 948E, 948F, 948G, 948H, 948I, 948J, 948K, 948P, 948Q, 948R, 948S, 948T, 948U, 948V, 948W, 948X, 948Y, and 948Z.

The fingers 948A-948K may be considered a plurality of medial fingers at a medial extent 949A of the uncured rubber layer 918A. The medial extent 949A includes the edges of the medial fingers 948A-948K and establishes (and may be referred to as) a medial edge of the uncured rubber layer 918A and, once cured, of the cured rubber layer 918. The fingers 948P-948Z may be considered a plurality of lateral fingers at a lateral extent 949B of the uncured rubber layer 918A.

The lateral extent 949B includes the edges of the lateral fingers 948P-948Z and may establish and be referred to as a lateral edge of the uncured rubber layer 918A and, once cured, of the rubber layer 918.

Notably, the fingers 948A-948K align with and are stacked on the fingers 944A-948K of the uncured rubber layer 916A, respectively, with each finger fingers 948A-948K having a lesser width than the respective finger 944A-948K on which it is stacked such that a peripheral portion of each finger 944A-948K at the distal side 931 of the rubber layer 916 is exposed at the distal side 932 of the monolithic component 914 as shown in FIG. 24.

The distal side 954 of the section 918AA has a recess 961 cut only partway through the thickness of the section 918AA. The uncured rubber layer 919A of FIG. 21 is stacked on the section 918AA at the recess 961 and nests at least partially in the recess 961. The uncured rubber layer 919A has a proximal side 963 that interfaces with the distal side 954 of the section 918AA at the recess 961 and is cross-linked thereto once the stacked rubber layers 916A, 918A, 919A, and 920A are cured as the monolithic component 914.

The nested rubber layer 919 in the cured monolithic component 914 shown in FIG. 24 may have a thickness from its proximal side 963 to its distal side 965 equal to the depth of the recess 961 such that a surface of the nested rubber layer 919 (e.g., the surface 921 at the distal side 965) is even in height with the surface 923 of the section 918AA at the distal side 954. In other words, the nested rubber layer 919 may be flush with the surface 923.

The rubber layer 919 may function to reinforce the sole structure 912 along its length in the midfoot region. In addition or in the alternative, the rubber layer 919 may be decorative, such as by being in the shape of a logo or displaying text printed thereon, or otherwise.

The section 918BB of the uncured rubber layer 918A is a strip that extends transversely across the distal side 931 of the uncured rubber layer 916A and aligns with and is cross-linked to the respective fingers 944L and 944O in the cured monolithic component 914 as indicated in FIGS. 23 and 24. The medial and lateral ends of the section 918BB are narrower than the fingers 944L and 944O so that the distal side 931 of the rubber layer 916 will be exposed at the distal side 932 of the cured monolithic component 914.

The section 918CC of the uncured rubber layer 918A is also a strip that extends transversely across the distal side 931 of the uncured rubber layer 916A and aligns with and is cross-linked to the respective fingers 944M and 944N in the cured monolithic component 914 as indicated in FIG. 23. The medial and lateral ends of the section 918CC are narrower than the fingers 944M and 944N so that the distal side 931 of the rubber layer 916 will be exposed at the distal side 932 of the cured monolithic component 914.

FIG. 22 is a plan view of the cut, uncured rubber layer 920A for the sole structure 912, which, once cured, will become the rubber layer 920 of FIG. 23, for example. The uncured rubber layer 920A may be cut from an uncured rubber sheet held on a sticky backing layer, like sticky backing layer 42, similar to the process for cutting the rubber layer 16A. Notably, the uncured rubber layer 920A is cut in nine discrete and discontinuous sections 920AA, 920BB, 920CC, 920DD, 920EE, 920FF, 920GG, 920HH, and 920II.

Referring to FIG. 22, the uncured rubber layer 920A is shown after a cutting process similar to that described with respect to the uncured rubber layer 16A, and after removal from a similar sticky backing layer 42. The section 920AA is a strip that extends transversely across the distal side 954 of the section 918AA and aligns with and is cross-linked to the respective fingers 948A and 948Z in the cured monolithic component 914 as indicated in FIGS. 23 and 24. The medial and lateral ends of the section 920AA are narrower than the respective fingers 948A and 948Z so that the distal side 954 of the rubber layer 918 will be exposed at the distal side 932 of the cured monolithic component 914.

The section 920BB of the uncured rubber layer 920A is also a strip that extends transversely across the distal side 954 of the uncured rubber layer 918A and aligns with and is cross-linked to the respective fingers 948B and 948Y in the cured monolithic component 914 as indicated in FIGS. 23 and 24. The medial and lateral ends of the section 920BB are narrower than the respective fingers 948B and 948Y so that the distal side 954 of the rubber layer 918 will be exposed at the distal side 932 of the cured monolithic component 914.

The section 920CC of the uncured rubber layer 920A is also a strip that extends transversely across the distal side 954 of the uncured rubber layer 918A and aligns with and is cross-linked to the respective fingers 948C and 948X in the cured monolithic component 914 as indicated in FIGS. 23 and 24. The medial and lateral ends of the section 920CC are narrower than the respective fingers 948C and 948X so that the distal side 954 of the rubber layer 918 will be exposed at the distal side 932 of the cured monolithic component 914.

The sections 920DD includes a plurality of fingers 960A, 960B, 960C, 960D, 960E, and 960F. The fingers 960A-960C may be considered a plurality of medial fingers at a medial extent 967A of the uncured rubber layer 920A. The medial extent 967A includes the edges of the medial fingers 9460A-960C and partially establishes (and may be referred to as) a medial edge of the section 920DD of the uncured rubber layer 918A and, once cured, of the rubber layer 920. The medial extremity of each of the other sections 920AA, 920BB, 920CC, 920EE, 920FF, 920GG, 920HH, and 920II also partially establish medial extents and medial edges of the rubber layer 920. The fingers 960D-960F may be considered a plurality of lateral fingers at a lateral extent 967B of the uncured rubber layer 920A.

The lateral extent 967B includes the edges of the lateral fingers 960D-960F and may establish and be referred to as a lateral edge of the section 920DD of the uncured rubber layer 920A and, once cured, of the rubber layer 920. The lateral extremity of each of the other sections 920AA, 920BB, 920CC, 820EE, 920FF, 920GG, 920HH, and 920II also partially establish lateral extents and lateral edges of the rubber layer 920.

Notably, the fingers 960A-960C align with and are stacked on the fingers 948D-948F of the section 918AA of the rubber layer 918, respectively, with each finger 960A-960C having a lesser width than the respective finger 948D-948F on which it is stacked such that a peripheral portion of each finger 948D-948F at the distal side 954 of the cured rubber layer 918 is exposed at the distal side 932 of the monolithic component 914 as shown in FIG. 24.

Similarly, the fingers 960D-960F align with and are stacked on the fingers 948U-948V, respectively, with each finger fingers 960D-960F having a lesser width than the respective finger 948U-948W on which it is stacked such that a peripheral portion of each finger 948U-948W at the distal side 954 of the cured rubber layer 918 is exposed at the distal side 932 of the monolithic component 914 as shown in FIG. 23.

The section 920EE of the uncured rubber layer 920A is a strip that extends transversely across the distal side 954 of the uncured rubber layer 918A and aligns with and is cross-linked to the respective fingers 948G and 948T in the cured monolithic component 914 as indicated in FIGS. 23 and 24. The medial and lateral ends of the section 920EE are narrower than the respective fingers 948G and 948T so that the distal side 954 of the cured rubber layer 918 will be exposed at the distal side 932 of the cured monolithic component 914.

The section 920FF of the uncured rubber layer 920A is also a strip that extends transversely across the distal side 954 of the uncured rubber layer 918A and aligns with and is cross-linked to the respective fingers 948H and 948S in the cured monolithic component 914 as indicated in FIGS. 23 and 24. The medial and lateral ends of the section 920FF are narrower than the respective fingers 948H and 948S so that the distal side 954 of the cured rubber layer 918 will be exposed at the distal side 932 of the cured monolithic component 914.

The section 920GG has a plurality of medial fingers 960G, 960H, and 960I aligned with and stacked on the fingers 948I, 948J, and 948K, respectively, with each finger 960G-960I having a lesser width than the respective finger 948I-948K on which it is stacked such that a peripheral portion of each finger 948I-948K at the distal side 954 of the cured rubber layer 918 is exposed at the distal side 932 of the monolithic component 914 as shown in FIG. 24.

Similarly, the section 920GG has a plurality of lateral fingers 960J, 960K, and 960L aligned with and stacked on the fingers 948P, 948Q, and 948R, respectively, with each finger 960J-960L having a lesser width than the respective finger 948P-948R on which it is stacked such that a peripheral portion of each finger 948P-948R at the distal side 954 of the cured rubber layer 918 is exposed at the distal side 932 of the monolithic component 914 as shown in FIG. 24.

The section 920HH of the uncured rubber layer 920A is a strip that extends transversely across the distal side 954 of the uncured rubber layer 918A and aligns with and is cross-linked to the respective section 918BB in the cured monolithic component 914 as indicated in FIG. 24. The medial and lateral ends of the section 920HH are narrower than the respective medial and lateral ends of the section 918BB so that the distal side 954 of the cured rubber layer 918 will be exposed at the distal side 932 of the cured monolithic component 914.

The section 920FF of the uncured rubber layer 920A is also a strip that extends transversely across the distal side 954 of the uncured rubber layer 918A and aligns with and is cross-linked to the section 918CC in the cured monolithic component 914 as indicated in FIG. 24. The medial and lateral ends of the section 920FF are narrower than the respective medial and lateral ends of the section 918CC so that the distal side 954 of the cured rubber layer 918 will be exposed at the distal side 932 of the cured monolithic component 914.

The stacked uncured rubber layers 916A, 918A, 919A, and 920A can be cured together in a mold to result in the monolithic component 914 shown in FIGS. 23 and 24. Notably, the rubber layers 916, 918, 919, and 920 are cured together, separately from any other components of the article of footwear 910, and the monolithic component 914 has the contoured shape shown in FIGS. 23 and 24, with the cupped proximal side and upturned fingers of the various rubber layers 916, 918, and 920.

The discrete sections 920EE and 920FF are secured to portions of the distal side 965 of the auxiliary layer 919 which is nested in the recess 961. Because the auxiliary layer 919 has a thickness equal to the depth of the recess 961 as discussed, the discrete sections 920EE and 920FF are not bumped further outward by the auxiliary layer 919 as they might if the auxiliary layer 919 were thicker than the recess 961.

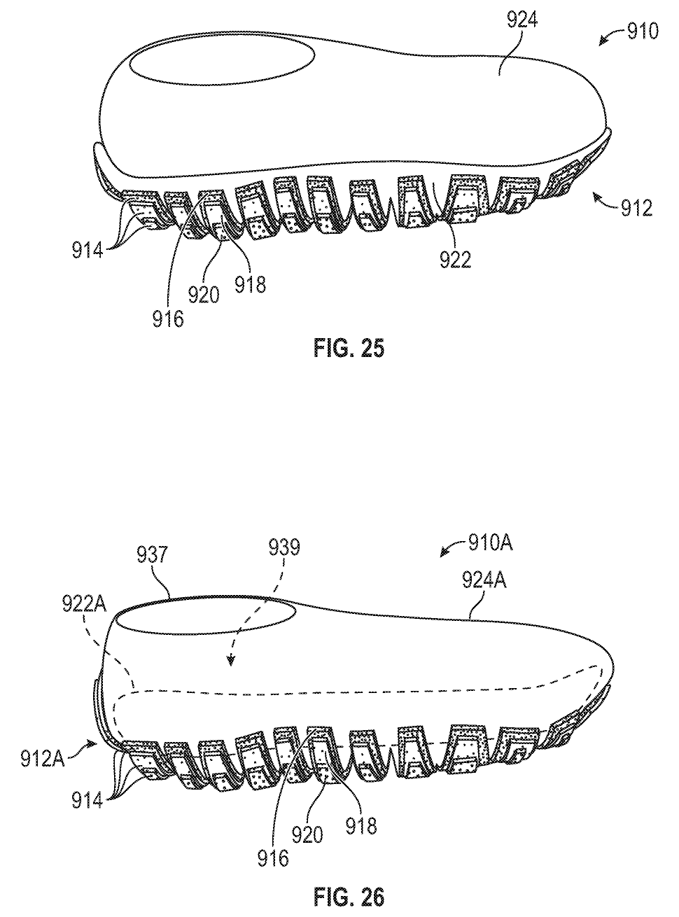

With this configuration, the monolithic component 914 is ready for stock fitting to a midsole, such as by adhering a proximal side 930 of the rubber layer 916 (indicated in FIG. 23, and indicated in FIG. 19 with respect to the uncured rubber layer 916A) to a foam midsole component 922 with adhesive as shown in the article of footwear 910 of FIG. 25 in which the monolithic component 914 serves as an outsole.

The article of footwear 910 is shown with a footwear upper 924 secured to the foam midsole component 922. Alternatively, the monolithic component 914 may be stock fit directly to a footwear upper 924A, such as in the article of footwear 910A shown in FIG. 26. For example, the footwear upper 924A may extend completely under the foot of the wearer, such as a sock-like footwear upper. The monolithic component 914 may be adhered directly to the exterior of the footwear upper 924A such as with adhesive. In such an implementation, a drop-in midsole 922A may be inserted into a foot-receiving cavity 939 through an ankle opening 937 of the footwear upper 924A so that a foot may be supported on the drop-in midsole 922A within the foot-receiving cavity 939 over the footwear upper 924A and the monolithic component 914.

A sole structure 912A in the article of footwear 910A includes both the monolithic component 914 serving as an outsole, and the drop-in midsole 922A.

The aligned fingers of the stacked, cured rubber layers 916, 918, and 920 may provide greater flexibility in dorsiflexion in the cured monolithic component 914 in both of the articles of footwear 910 and 910A, for example, than would a monolithic component including layers that extend upward along the sides of the foam midsole component 922 in FIG. 25 or the footwear upper 924A in FIG. 26 without any cuts or fingers at the medial and lateral extents.

FIG. 27 is a bottom perspective view of another article of footwear 1010 including a sole structure 1012 with a monolithic component 1014 of multiple stacked rubber layers. The sole structure 1012 also includes a foam midsole layer 1022. The monolithic component 1014 is configured as and may be referred to as an outsole. A footwear upper 1024 is shown secured to the foam midsole layer 1022.

The multiple stacked rubber layers include a first rubber layer 1020, a second rubber layer 1018, and an auxiliary layer 1019, which may also be referred to as an additional rubber layer. Each of the first rubber layer 1020, the second rubber layer 1018, and the auxiliary layer 1019 have at least one different property than one another, such as a different hardness or color, as discussed herein. In some examples, only the first rubber layer 1020 and the second rubber layer 1018 have at least one different property than one another. The first rubber layer 1020, the second rubber layer 1018, and the auxiliary layer 1019 are first stacked together as cut, uncured rubber layers in the order shown and then cured together so that interfacing sides of the adjacent cured rubber layers are secured to one another by cross-linking and without any adhesive.

The monolithic component 1014 has a proximal side 1050 (proximal side of the second rubber layer 1018) that is secured to the foam midsole layer 1022 and a distal side 1032 (distal side of the first rubber layer 1020) and are stacked in a direction from the proximal side 1050 of the second rubber layer 1018 to the distal side 1032 of the first rubber layer 1020. The proximal side 1050 and the distal side 1032 establish the proximal and distal sides of the monolithic component 1014, respectively. As shown, all of the stacked rubber layers 1020, 1019, and 1018 are exposed at the distal side 1032.

The first rubber layer 1020 is configured as a plurality of discrete strips 1020A, 1020B, 1020C, 1020D, 1020E, 1020F, 1020G, 1020H, 1020I, 1020J, 1020K, 1020L, 1020M, 1020N, and 1020O. The strips 1020A-1020O are also referred to herein as sections. Accordingly, the monolithic component 1014 includes only two stacked rubber layers in most portions of the forefoot, midfoot, and heel regions 10A, 10B, and 10C, with the auxiliary layer 1019 nested in a recess 1061 in the distal side 1054 of the second rubber layer 1018 and having a thickness equal to the depth of the recess 1061 so that the distal surface 1021 of the nested auxiliary layer 1019 is even in height with the distal surface 1023 of the second rubber layer 1018 at the distal side 1054. In other words, the nested rubber layer 1019 may be flush with the surface 1023.

The discrete spaced strips 1020H, 1020I, 1020J, and 1020K of the second rubber layer 1018 overlay portions of the auxiliary layer 1019 such that other portions of the auxiliary layer 1019 between adjacent ones of the spaced strips 1020H, 1020I, 1020J, and 1020K, for example, are exposed at the distal side 1032. The distal side 1032 of the first rubber layer 1020 (indicated at one of the strips 1020I, for example) establishes the ground contact surface 1033 (indicated in FIG. 27 with respect to one of the strips 1020E). Due to the spacing between the strips 1020A-1020O, under sufficient compressive loading, the distal side 1054 of the second rubber layer 1018 also defines a portion of the ground contact surface 1033 of the monolithic component 1014.

The second rubber layer 1018 includes a plurality of fingers 1048 at the medial side 26 that establish the medial extent of the second rubber layer 1018. The second rubber layer 1018 has a proximal surface at proximal side 1050 that is secured to a distal surface 1051 of the foam midsole layer 1022 so that the fingers 1048 wrap at least partially up the medial side wall of the foam midsole layer 1022 as shown in FIG. 27. The lateral side of the second rubber layer 1018 is not shown in FIG. 27 and may also have similar lateral fingers.

The discrete strips 1020A-1020Oof the first rubber layer 1020 each form protrusions of a single layer of thickness and extend transversely across (e.g., laterally across) a longitudinal midline LA of the article of footwear 1010 and of the outsole (e.g., of the monolithic component 1014) from the medial side 26 to the lateral side 28. Additionally, the single layer protrusions formed by the discrete strips 1020A-1020O extend fore and aft (e.g., toward the forward extent of the forefoot region 10A and toward the rear extent of the heel region 10C) in a nonlinear orientation as each of the discrete strips 1020A-1020O has a wavy configuration as shown.

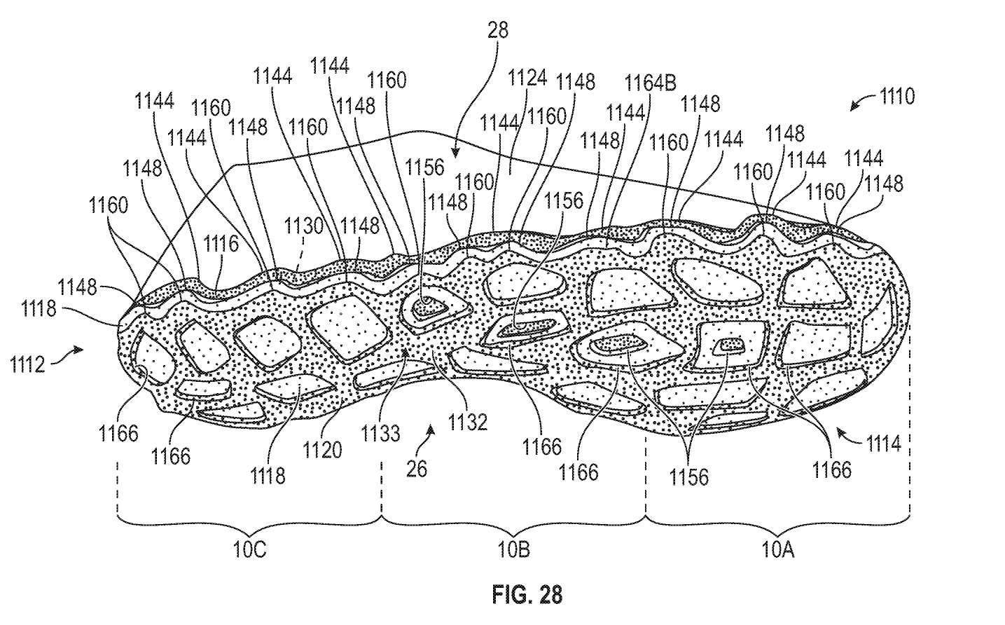

FIG. 28 is a bottom perspective view of another article of footwear 1110 including a sole structure 1112 with an outsole having a monolithic component 1114 of multiple stacked rubber layers 1116, 1118, and 1120. The monolithic component 1114 is configured as and may be referred to as an outsole.

The multiple stacked rubber layers include a first rubber layer 1120, a second rubber layer 1118, and a third rubber layer 1116. Each of the first rubber layer 1120, the second rubber layer 1118, and the third rubber layer 1116 have at least one different property than one another, such as a different hardness or color, as discussed herein. In some examples, only the second rubber layer 1118 has at least one different property than each of the first rubber layer 1120 and the third rubber layer 1116. The first rubber layer 1120, the second rubber layer 1118, and the third rubber layer 1116 are first stacked together as cut, uncured rubber layers in the order shown and then cured together so that interfacing sides of the adjacent layers are secured to one another by cross-linking and without any adhesive.

The monolithic component 1114 has a proximal side 1130 (proximal side of the third rubber layer 1116) that is secured directly to a footwear upper 1124 and a distal side 1132 (distal side of the first rubber layer 1120) and are stacked in a direction from the proximal side 1130 to the distal side 1132. The proximal side 1130 and the distal side 1132 establish the proximal and distal sides of the monolithic component 1114, respectively. As shown, all of the stacked rubber layers 1120, 1118, and 1116 are exposed at the distal side 1132.

The first rubber layer 1120 is configured with a plurality of through holes 1166 in each of the forefoot region, 10A, the midfoot region 10B, and the heel region 10C. Only some of the through holes 1166 are labeled in FIG. 28. The first rubber layer 1120 also has a plurality of relatively short lateral fingers 1160 at a lateral edge 1164B that wrap up onto and are secured to similarly spaced lateral fingers 1148 of the second rubber layer 1118. Similar fingers may be disposed at the medial side and may wrap up onto fingers of the second rubber layer 1118 at the medial side.

The second rubber layer 1118 has a plurality of through holes 1156 that align with some of the through holes 1166 of the first rubber layer 1120, although there are fewer through holes in the second rubber layer 1118 than in the first rubber layer 1120 so that the second rubber layer 1118 spans entirely across many of the through holes 1166 of the first rubber layer 1120.

The second rubber layer 1118 also has a plurality of lateral fingers 1148 that wrap up onto and are secured to similarly spaced fingers 1144 of the third rubber layer 1116 at the lateral side 28. The second rubber layer 1118 may have similar fingers that may be disposed at the medial side 26 and may wrap up onto fingers of the third rubber layer 1116 at the medial side.

The third rubber layer 1116 has no through holes that align with the aligned through holes 1156 and 1166 and may have no through holes whatsoever. Accordingly, the third rubber layer 1116 spans across and is exposed at the distal side 1132 at the aligned through holes 1156 and 1166.

The distal side 1132 of the first rubber layer 1120 establishes the ground contact surface 1133 and also establishes the distal side and the ground contact surface of the monolithic component 1114. Due to the aligned through holes 1156 and 1166 exposing the second rubber layer 1118 and the third rubber layer 1116 at the distal side, the second rubber layer 1118 and the third rubber layer 1116 may also define a portion of the ground contact surface 1133 of the monolithic component 1114 under sufficient compressive loading.

FIG. 29 is a bottom perspective view of another article of footwear 1210 including a sole structure 1212 with an outsole having a monolithic component 1214 of multiple stacked rubber layers 1216, 1218, and 1220. The monolithic component 1214 is configured as and may be referred to as an outsole.

The multiple stacked rubber layers include a first rubber layer 1220, a second rubber layer 1218, and a third rubber layer 1216. Each of the first rubber layer 1220, the second rubber layer 1218, and the third rubber layer 1216 have at least one different property than one another, such as a different hardness or color, as discussed herein. In some examples, only the second rubber layer 1218 has at least one different property than each of the first rubber layer 1220 and the third rubber layer 1216.

The first rubber layer 1220, the second rubber layer 1218, and the third rubber layer 1216 are first stacked together as cut, uncured rubber layers in the order shown and then cured together so that interfacing sides of the adjacent layers are secured to one another by cross-linking and without any adhesive.

The monolithic component 1214 has a proximal side 1230 (proximal side of the third rubber layer 1216) that is secured directly to a footwear upper 1224 and a distal side 1232 (distal side of the first rubber layer 1220) and are stacked in a direction from the proximal side 1230 to the distal side 1232. The proximal side 1230 and the distal side 1232 establish the proximal and distal sides of the monolithic component 1214, respectively. As shown, all of the stacked rubber layers 1220, 1218, and 1216 are exposed at the distal side 1232.

The first rubber layer 1220 is configured as a plurality of discrete sections that may be referred to as pods, and each discontinuous from one another and secured at a proximal side to a distal side of a corresponding discontinuous section (e.g., pods) of the second rubber layer 1218. The second rubber layer 1218 is also configured as a plurality of discrete and discontinuous sections (e.g., pods) each having a proximal side secured to a distal side of the third rubber layer 1216. The discrete, discontinuous sections of the second rubber layer 1218 may have edges that abut one another but are shaped such that a portion of the distal side of the third rubber layer 1216 is exposed at the distal side 1232 between adjacent ones of the sections of the first rubber layer 1220 and of the second rubber layer 1218.

Only some of the sections of the second rubber layer 1218 are labeled in FIG. 29. The discrete, discontinuous sections of the second rubber layer 1218 have a greater surface area at their distal sides than the corresponding discrete, discontinuous sections of the first rubber layer 1220 that are secured thereon. Accordingly, a periphery of the second rubber layer 1218 is exposed around each of the discrete, discontinuous sections of the first rubber layer 1220.

The third rubber layer 1216 has a plurality of relatively short lateral fingers 1244 at a lateral edge 1264B that wrap up onto and are secured to the footwear upper 1224 at the lateral side 28 of the footwear upper 1224. Similar fingers may be disposed at the medial side and may wrap up onto the footwear upper 1224 at the medial side.

The distal side 1232 of the first rubber layer 1220 establishes the ground contact surface 1233. The ground contact surface 1233 is labelled at one of the sections of the first rubber layer 1220 in FIG. 29. Due to the pod-like shapes of the discrete, discontinuous sections of the first rubber layer 1220 and the second rubber layer 1218, the second rubber layer 1218 and the third rubber layer 1216 may also define a portion of the ground contact surface 1233 of the monolithic component 1214 under sufficient compressive or shear loading. More specifically, the stacked discrete discontinuous sections of the first rubber layer 1220 and the second rubber layer 1218 define protrusions 1270 at the distal side 1232 with both of the first rubber layer 1220 and the second rubber layer 1218 exposed along a longitudinal axis 1272 of the protrusion 1270. Only one such protrusion 1270 is labeled in FIG. 29.

As discussed herein with respect to other embodiments in which the monolithic component defines protrusions from multiple stacked rubber layers, under sufficient compressive and/or shear loading, the second rubber layer 1218 and the third rubber layer 1216 may become part of the ground contact surface 1233. Accordingly, different properties of the rubber layers 1220, 1218 and 1216 may be selected to influence such compressibility and friction with the ground plane when the additional rubber layers 1218 and 1216 become part of the ground contact surface 1233.

Moreover, some of the discrete, discontinuous sections of the rubber layers 1218 and 1220 could be stacked in a different order, such as in different regions 10A, 10B, 10C or different portions of the regions 10A, 10B, and 10C so that some of the discrete, discontinuous sections of the first rubber layer 1220 are stacked against the proximal side of the third rubber layer 1216 and the discrete discontinuous sections of the second rubber layer 1218 are stacked on the proximal side of those sections of the first rubber layer 1220. With such an arrangement, the different properties of the first and second rubber layers 1220, 1218 might be targeted to provide a different cushioning response and/or durability or grip at different regions of the article of footwear 1210.

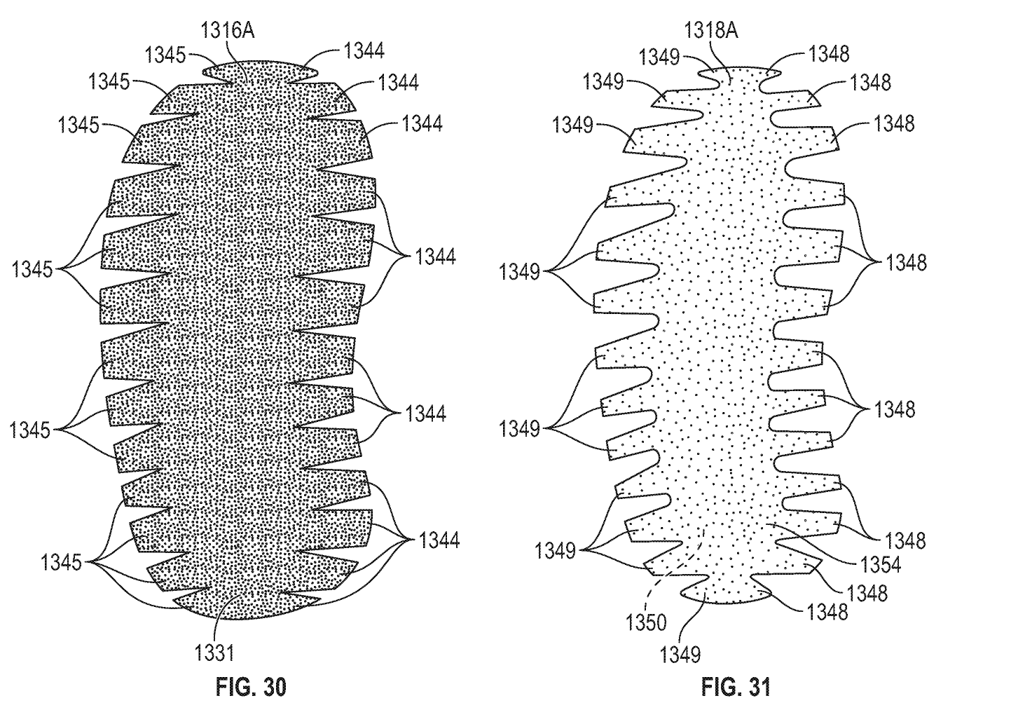

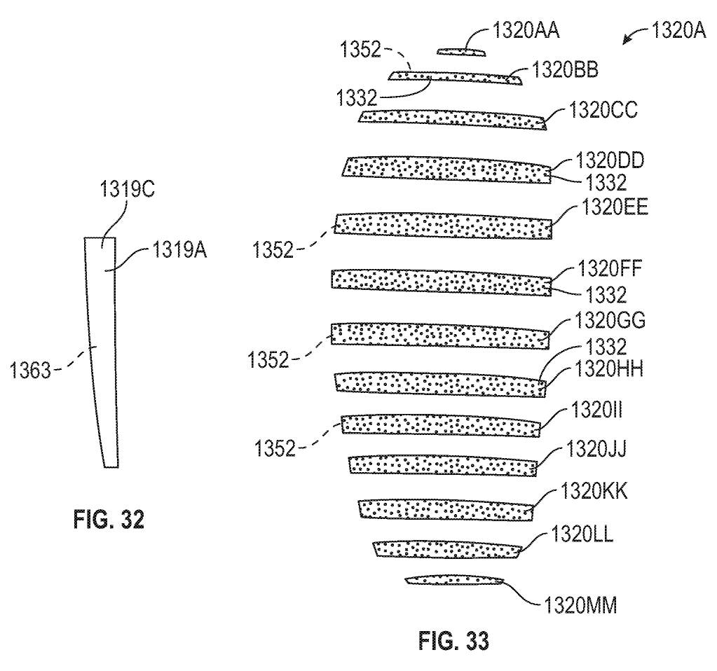

FIG. 30 is a plan view of a cut uncured rubber layer 1316A for the sole structure 1312 included in the article of footwear 1310 of FIG. 34. FIG. 31 is a plan view of another cut, uncured rubber layer 1318A for the monolithic component 1314 of the sole structure 1312 of FIG. 34. FIG. 32 is a plan view of another cut, uncured rubber layer 1319A for the monolithic component 1314 of the sole structure 1312 of FIG. 34. FIG. 33 is a plan view of another cut, uncured rubber layer 1320A for the monolithic component 1314 of the sole structure of FIG. 34, including a plurality of discrete sections or strips as discussed herein.

FIG. 34 is a bottom perspective view of the article of footwear 1310 including the sole structure 1312 after stacking the uncured rubber layers 1316A, 1318A, 1319A, and 1320A of FIGS. 30-33 and curing to secure the cured rubber layers to one another as a monolithic component 1314. The uncured rubber layers 1316A, 1318A, 1319A, and 1320A become rubber layers 1316, 1318, 1319, and 1320, respectively, once cured. The cured rubber layers may be referred to as a first rubber layer 1320, a second rubber layer 1318, and a third rubber layer 1316. The cured rubber layer 1319 may be referred to as an auxiliary rubber layer or as an additional rubber layer.

Each of the uncured rubber layers 1316A, 1318A, 1319A, and 1320A may be cut from respective rubber sheets held on sticky backing layers, like sticky backing layer 42, similar to the process for cutting the rubber layer 16A. After cutting and once cured together with uncured rubber layers 1318A, 1320A, and 1319A as discussed herein, the uncured rubber layer 1316A will become the rubber layer 1316 that is cross-linked to the adjacent rubber layer 1318 at an interface as discussed herein. More specifically, a distal side 1331 of the rubber layer 1316 will be cross-linked to a proximal side 1350 of the rubber layer 1318, with the distal side 1331 and the proximal side 1350 defining the interface. Similarly the cured rubber layer 1320 will be cross-linked to the adjacent rubber layer 1318 at the interface of the proximal side of each discrete strip of the rubber layer 1320 (indicated as proximal side 1352 with respect to one of the sections 1320BB for purposes of illustration in FIG. 33) and the distal side 1354 of the rubber layer 1318.

At least the uncured rubber layers 1316A, 1318A, 1319A, and 1320A (and, once cured, rubber layers 1316, 1318, 1319, and 1320) may each have at least one different property, such as hardness, color, etc., as discussed with respect to the uncured rubber layers 16A, 18A, and 20A for example. In other examples, only two of the uncured rubber layers 1316A, 1318A, and 1320A need have a different property from one another. The uncured rubber layer 1319A may have the same properties as any one of the other uncured rubber layers 1316A, 1318A, and 1320A or a different property from each of the other uncured rubber layers 1316A, 1318A, and 1320A.

FIG. 30 shows the cut, uncured rubber layer 1316A includes a plurality of medial fingers 1344 and a plurality of lateral fingers 1345 that are disposed at and define a medial extent and a lateral extent of the uncured rubber layer 1316A, respectively. The uncured rubber layer 1316A is shown after a cutting process similar to that described with respect to the rubber layer 16A, and after removal from a similar sticky backing layer 42. The cut, uncured rubber layer 1316A includes a plurality of medial fingers 1344 and a plurality of lateral fingers 1345 that are disposed at and define a medial extent and a lateral extent of the uncured rubber layer 1316A, respectively.

FIG. 31 is a plan view of the cut, uncured rubber layer 1318A for the sole structure 1312, which, once cured, will become the rubber layer 1318 of FIG. 34, for example. The uncured rubber layer 1318A is shown after a cutting process similar to that described with respect to the rubber layer 16A, and after removal from a similar sticky backing layer 42. The cut, uncured rubber layer 1318A includes a plurality of medial fingers 1348 and a plurality of lateral fingers 1349 that are disposed at and define a medial extent and a lateral extent of the uncured rubber layer 1318A, respectively.

Notably, the medial fingers 1348 align with and are stacked on the medial fingers 1344, respectively, with each medial finger 1348 having a lesser width than the respective medial finger 1344 on which it is stacked such that a peripheral portion of each finger 1344 at the distal side 1331 of the rubber layer 1316 is exposed at the distal side 1332 of the monolithic component 1314 as shown in FIG. 34. Similarly, the lateral fingers 1349 align with and are stacked on the lateral fingers 1345, respectively, with each lateral finger 1349 having a lesser width than the respective lateral finger 1345 on which it is stacked such that a peripheral portion of each finger 1345 at the distal side 1331 of the rubber layer 1316 is exposed at the distal side 1332 of the monolithic component 1314 as shown in FIG. 34.

The uncured rubber layer 1319A is interwoven with the discrete sections (also referred to herein as strips) of the uncured rubber layer 1320A as discussed herein so that, once cured, a proximal side 1363 of the rubber layer 1319 interfaces with the distal side 1354 of the rubber layer 1318 and the proximal side 1352 of at least one of the strips 1320EE, 1320GG, and 1320II, and is cross-linked thereto, and with the distal side 1332 of at least one other of the sections 1320DD, 1320FF, and 1320HH and is cross-linked thereto once the stacked layers 1316, 1318, 1319, and 1320 are cured as the monolithic component 1314.

The rubber layer 1319 extends lengthwise in a fore-aft direction of the sole structure 1312 and may function to reinforce the sole structure 1312 along its length, such as in the midfoot region 10B. In addition or in the alternative, the rubber layer 1319 may be decorative, such as in the shape of a logo or displaying text printed thereon, or otherwise.

FIG. 33 is a plan view of the cut, uncured rubber layer 1320A for the sole structure 1312, which, once cured, will become the rubber layer 1320 of FIG. 34, for example. Notably, the uncured rubber layer 1320A is cut in thirteen discrete and discontinuous sections 1320AA, 1320BB, 1320CC, 1320DD, 1320EE, 1320FF, 1320GG, 1320HH, 1320II, 1320JJ, 1320KK, 1320LL, and 1320MM.

Each of the strips of the uncured rubber layer 1320A aligns with a respective pair of medial and lateral fingers 1348, 1349 of the rubber layer 1318A and extends transversely across the distal side 1354 of the rubber layer 1318A at the pair of fingers 1348, 1349. The medial and lateral ends of each of the sections 1320AA-1320MM are narrower than the respective fingers 1348 and 1349 with which each aligns so that the distal side 1354 of the rubber layer 1318 will be exposed at the distal side 1332 of the cured monolithic component 1314 as shown in FIG, 34.

The sections 1320AA-1320MM may be placed on the distal side 1354 of the uncured rubber layer 1318A in alignment with the respective fingers 1348, 1349 as discussed prior to placing the uncured rubber layer 1319A in position on the uncured, stacked layers 1318A, 1320A. Specifically, the uncured rubber layer 1319A may be interwoven with the discrete sections of the first uncured rubber layer 1320A by laying its forward end 1319C over the distal side 1332 of the section 1320DD, then laying the uncured rubber layer 1319A under the section 1320EE (by temporarily lifting the section 1320EE away from the distal side 1354 of the uncured rubber layer 1318A), then laying the uncured rubber layer 1319A over the distal side 1332 of the section 1320FF, then laying the uncured rubber layer 1319A under the section 1320GG (by temporarily lifting the section 1320GG away from the distal side 1354 of the uncured rubber layer 1318A), then laying the uncured rubber layer 1319A over the distal side 1332 of the section 1320HH, and then laying the uncured rubber layer 1319A under the section 1320II (by temporarily lifting the section 1320II away from the distal side 1354 of the uncured rubber layer 1318A). In this manner, the rubber layer 1319 will appear interwoven with some of the sections of the rubber layer 1320 in the cured, monolithic component 1314 as shown in FIG. 34.

Additionally, portions of the rubber layer 1319 will not only be exposed at the distal side 1332, but will also form part of the ground contact surface 1333. A texture may be imparted on the rubber layer 1319 or on any of the other rubber layers 1316, 1318, and 1320 such as to increase traction, for example.

The stacked uncured rubber layers 1316A, 1318A, 1319A, and 1320A can be cured together in a mold to result in the monolithic component 1314 shown in FIG. 34. The rubber layers 1316, 1318, 1319, and 1320 may be cured separately from any other components of the article of footwear 1310 similar to the rubber layers of FIGS. 23-24, for example to have a contoured shape like that shown in FIGS. 23 and 24, to result in the cupped proximal side and upturned fingers and ends of the various rubber layers 1316, and 1318, and 1320. With such a configuration, the monolithic component 1314 is ready for stock fitting directly to a footwear upper 1324 with adhesive as shown in FIG. 34, similar to as described with respect to the monolithic component 914 of the article of footwear 910A of FIG. 26.

A drop-in midsole may be placed in the footwear upper 1324. Alternatively, the monolithic component 1314 may be stock fit to a midsole, such as by adhering to a foam midsole component similar to as described with respect to the article of footwear 910 of FIG. 25.

Although the examples shown in the figures are discussed as being rubber layers, in other examples, any of the layers shown and described as being rubber layers in any of the examples herein could be a material other than rubber, and secured to one another with thermal bonds without adhesive to define a monolithic component. For example, each of the layers 16, 18, and 20 in FIG. 1 could be a nonrubber material, such as but not limited to thermoplastic polyurethane, stacked on one another, with adjacent ones of the layers secured to one another with thermal bonds created by heat and, in some instances, pressure, and without adhesive to define the monolithic component 14.

The following Clauses provide example configurations of an article of footwear disclosed herein.

Clause 1. An article of footwear comprising: a sole structure including: rubber layers stacked on one another; wherein adjacent ones of the rubber layers are secured to one another with cross-linking and without adhesive such that the rubber layers define a monolithic component having a proximal side and a distal side, the rubber layers being stacked in a direction from the proximal side to the distal side; and wherein at least two of the rubber layers are exposed at the distal side, and have at least one different property.

Clause 2. The article of footwear of clause 1, wherein the at least two of the rubber layers at least partially define a ground contact surface of the sole structure at the distal side.

Clause 3. The article of footwear of clause 2, wherein the at least two of the rubber layers defining the ground contact surface comprise an outsole.

Clause 4. The article of footwear of any of clauses 1-3, further comprising: a footwear upper; and wherein the monolithic component wraps upward onto and is secured to the footwear upper at a medial side of the footwear upper and at a lateral side of the footwear upper.

Clause 5. The article of footwear of clause 4, the sole structure further comprising: a drop-in midsole disposed in a foot-receiving cavity of the article of footwear.

Clause 6. The article of footwear of any of clauses 2-3, wherein the sole structure further includes a foam midsole layer disposed inward of the proximal side of the monolithic component.

Clause 7. The article of footwear of clause 6, wherein the monolithic component wraps upward onto and is secured to the foam midsole layer at a medial side of the foam midsole layer and at a lateral side of the foam midsole layer.

Clause 8. The article of footwear of clause 6, wherein: the rubber layers define at least partially aligned through holes extending through the monolithic component from the proximal side to the distal side; and the foam midsole layer is exposed from the distal side at the through holes.

Clause 9. The article of footwear of clause 8, wherein the foam midsole layer extends at least partially through at least some of the through holes toward the distal side.

Clause 10. The article of footwear of any of clauses 1-9, wherein: the at least two of the rubber layers include a first rubber layer and a second rubber layer; the first rubber layer and the second rubber layer define a protrusion at the distal side of the article of footwear; the first rubber layer is disposed as an outermost portion of the protrusion along a vertical axis of the protrusion; and the second rubber layer is exposed along the protrusion proximal to the first rubber layer.

Clause 11. The article of footwear of clause 10, wherein: the first rubber layer has a first hardness and the second rubber layer has a second hardness different than the first hardness.

Clause 12. The article of footwear of clause 11, wherein: the rubber layers include a third rubber layer disposed adjacent to the second rubber layer with the second rubber layer between the first rubber layer and the third rubber layer; and wherein the third rubber layer has a third hardness different than the second hardness.

Clause 13. The article of footwear of clause 12, wherein the protrusion includes the first rubber layer and the second rubber layer and not the third rubber layer.

Clause 14. The article of footwear of any one of clauses 10 to 13, wherein the protrusion extends laterally across a longitudinal midline of the monolithic component.

Clause 15. The article of footwear of clause 14, wherein the protrusion extends fore and aft in a nonlinear orientation.

Clause 16. The article of footwear of clause 14 or 15, wherein the first rubber layer includes discrete strips extending transversely from a medial side to a lateral side of the sole structure.

Clause 17. The article of footwear of any one of clauses 10-16, wherein: a proximal side of the first rubber layer and a distal side of the second rubber layer meet at and define an interface; the first rubber layer has a first color at the interface and the second rubber layer has a second color different than the first color at the interface.

Clause 18. The article of footwear of any one of clauses 10-17, wherein at least one of the rubber layers has a recess extending partway or completely through a thickness of the at least one of the rubber layers.

Clause 19. The article of footwear of clause 18, wherein the first rubber layer defines a through hole extending through the first rubber layer and exposing at least one other of the rubber layers at the through hole.

Clause 20. The article of footwear of any of clauses 1-19, wherein: at least two of the rubber layers have discrete, discontinuous sections; and the sections of at least two of the rubber layers are stacked in a different order relative to one another in a first region of the article of footwear than in a second region of the article of footwear.

Clause 21. The article of footwear of any of clauses 1-20, wherein at least one of the rubber layers defines a plurality of medial fingers at a medial extent of the at least one of the rubber layers and establishing a medial edge of the at least one of the rubber layers, and a plurality of lateral fingers at a lateral extent of the at least one of the rubber layers and establishing a lateral edge of the at least one of the rubber layers.

Clause 22. The article of footwear of any of clauses 1-21, wherein the rubber layers include: a first rubber layer that has a plurality of discrete sections spaced apart from one another; a second rubber layer having a distal side secured to a proximal side of the discrete sections of the first rubber layer; and an additional rubber layer that has a proximal side that interfaces with the distal side of the second rubber layer and with the proximal side of at least one of the discrete sections and is cross-linked thereto, and interfaces with a distal side of at least one other of the discrete sections and is cross-linked thereto.

Clause 23. The article of footwear of clause 22, wherein the additional rubber layer extends lengthwise in a fore-aft direction of the sole structure.

Clause 24. The article of footwear of any of claims 1-23, wherein the at least one different property is at least one of a different color, transparency, translucency, hardness, elastic modulus, thickness, material, or grade of material.

Clause 25. A method of manufacturing an article of footwear, specifically according to any of clauses 1-24, the method comprising: stacking multiple uncured rubber layers without adhesive between adjacent ones of the multiple uncured rubber layers; after the stacking, curing the multiple uncured rubber layers as a monolithic component of a sole structure of the article of footwear such that adjacent ones of the rubber layers are secured to one another by cross-linking; wherein the monolithic component has a distal side and a proximal side, the rubber layers being stacked in a direction from the proximal side to the distal side; and wherein at least two of the rubber layers are exposed at the distal side and have at least one different property.

Clause 26. The method of manufacturing of clause 25, wherein the at least two of the rubber layers at least partially define a ground contact surface of the sole structure.

Clause 27. The method of manufacturing the article of footwear of clause 25 or 26, wherein the at least two of the rubber layers include a first rubber layer and a second rubber layer, and the method of manufacturing the article of footwear further comprising: forming or cutting the rubber layers either prior to or after the curing such that: at least the first rubber layer and the second rubber layer define a protrusion at the distal side of the monolithic component; the first rubber layer is disposed as an outermost portion of the protrusion along a vertical axis of the protrusion; and the second rubber layer is exposed along the protrusion proximal to the first rubber layer.

Clause 28. The method of manufacturing the article of footwear of any of clauses 25-27, wherein the at least two of the rubber layers include a first rubber layer and a second rubber layer, and the method of manufacturing an article of footwear further comprising: forming or cutting through holes in at least the first rubber layer and the second rubber layer prior to the stacking; and wherein the stacking multiple uncured rubber layers includes at least partially aligning the through holes in the first rubber layer with the through holes in the second rubber layer.

Clause 29. The method of manufacturing the article of footwear of clause 28, wherein the stacking multiple uncured rubber layers is in a mold, and the method of manufacturing the article of footwear further comprising: injecting foam into the mold to form a foam midsole layer such that the injected foam extends through the at least partially aligned through holes.

Clause 30. The method of manufacturing the article of footwear of any of clauses 25-29, wherein: the at least two of the rubber layers include a first rubber layer and a second rubber layer; the stacking multiple uncured rubber layers includes registering the first rubber layer to a mold within a mold cavity of the mold prior to stacking the second rubber layer on the first rubber layer; and the curing is in the mold.

Clause 31. The method of manufacturing the article of footwear of any of clauses 25-30, wherein the at least two of the rubber layers include a first rubber layer and a second rubber layer, and the method of manufacturing an article of footwear further comprising: forming or cutting through holes in at least the first rubber layer and the second rubber layer either prior to or after the stacking and prior to the curing.

Clause 32. The method of manufacturing the article of footwear of clause 31, further comprising: ejecting cut portions of the stacked multiple layers at the through holes via a die.

Clause 33. The method of manufacturing the article of footwear of any of clauses 25-32, wherein the stacking multiple uncured rubber layers is in a mold, and the method of manufacturing the article of footwear further comprising: injecting foam into the mold to form a foam midsole layer and such that the injected foam extends through the at least partially aligned through holes.

Clause 34. The method of manufacturing the article of footwear of any of clauses 25-33, wherein the stacking multiple uncured rubber layers is in a mold, and the method of manufacturing the article of footwear further comprising: placing a preform of a foam midsole layer in the mold prior to the curing such that the preform forms a foam midsole layer and the monolithic component thermally bonds to the foam midsole layer during or after the curing.

Clause 35. The method of manufacturing the article of footwear of any of clauses 25-34, wherein the stacking multiple uncured rubber layers is in a mold, and the method of manufacturing the article of footwear further comprising: placing a footwear upper in the mold prior to the curing such that the monolithic component thermally bonds to the footwear upper during or after the curing.

Clause 36. The method of manufacturing the article of footwear of clause 35, further comprising: placing a drop-in midsole into a foot-receiving cavity of the footwear upper.

Clause 37. The method of manufacturing of any of clauses 25-36, wherein the at least two of the rubber layers exposed at the distal side of the monolithic component include a first uncured rubber layer having discrete sections spaced apart from one another and a second uncured rubber layer interfacing with a proximal side of the discrete sections of the first uncured rubber layer, and wherein the stacking multiple uncured rubber layers includes: intertwining an additional uncured rubber layer with the discrete sections of the first uncured rubber layer so that the additional uncured rubber layer interfaces with a distal side of at least one of the discrete sections and with the proximal side of at least one other of the discrete sections.

Clause 38. A method of manufacturing an article of footwear, specifically according to any of clauses 1-24, the method comprising: stacking multiple uncured rubber layers without adhesive between adjacent ones of the multiple uncured rubber layers and such that through holes of at least some of the stacked multiple uncured layers are at least partially aligned with one another; and curing the stacked multiple uncured rubber layers as a monolithic component such that adjacent ones of the rubber layers are secured to one another by cross-linking.

Clause 39. The method of manufacturing the article of footwear of clause 38, further comprising: cutting the through holes either prior to or after the stacking and prior to the curing.

Clause 40. The method of manufacturing the article of footwear of clause 39, further comprising: ejecting cut portions of the stacked multiple layers at the through holes via a die.

Clause 41. The method of manufacturing of any of clauses 38-40, further comprising: cutting a recess only partway through a depth of at least one of the multiple uncured rubber layers either prior to or after the stacking.

Clause 42. The method of manufacturing of any of clauses 38-41, wherein at least one of the multiple uncured rubber layers has a sufficiently soft durometer such that friction between the at least one of the multiple uncured rubber layers and an adjacent one of the multiple uncured rubber layers prevents shifting of the adjacent ones of the multiple uncured rubber layers after the stacking and prior to the curing.

Clause 43. An article of footwear, specifically according to any of clauses 1-24, comprising: a sole structure including: layers stacked on one another; wherein adjacent ones of the layers are secured to one another with thermal bonds and without adhesive such that the layers define a monolithic component having a proximal side and a distal side, the layers being stacked in a direction from the proximal side to the distal side; and wherein at least two of the layers are exposed at the distal side, and have at least one different property.

Clause 44. The article of footwear of clause 43, wherein the at least two of the layers at least partially define a ground contact surface of the sole structure at the distal side.

Clause 45. The article of footwear of clause 44, wherein the at least two of the layers defining the ground contact surface comprise an outsole.

Clause 46. The article of footwear of any of clauses 43-45, further comprising: a footwear upper; and wherein the monolithic component wraps upward onto and is secured to the footwear upper at a medial side of the footwear upper and at a lateral side of the footwear upper.

Clause 47. The article of footwear of any of clauses 43-46, the sole structure further comprising: a drop-in midsole disposed in a foot-receiving cavity of the article of footwear.

Clause 48. The article of footwear of any of clauses 43-47, wherein the sole structure further includes a foam midsole layer disposed inward of the proximal side of the monolithic component.

Clause 49. The article of footwear of clause 48, wherein the monolithic component wraps upward onto and is secured to the foam midsole layer at a medial side of the foam midsole layer and at a lateral side of the foam midsole layer.

Clause 50. The article of footwear of clause 48 or 49, wherein: the layers define at least partially aligned through holes extending through the monolithic component from the proximal side to the distal side; and the foam midsole layer is exposed from the distal side at the through holes.

Clause 51. The article of footwear of clause 50, wherein the foam midsole layer extends at least partially through at least some of the through holes toward the distal side.

Clause 52. The article of footwear of any of clauses 43-47, wherein: the at least two of the layers include a first layer and a second layer; the first layer and the second layer define a protrusion at the distal side of the article of footwear; the first layer is disposed as an outermost portion of the protrusion along a vertical axis of the protrusion; and the second layer is exposed along the protrusion proximal to the first layer.

Clause 53. The article of footwear of clause 52, wherein: the first layer has a first hardness and the second layer has a second hardness different than the first hardness.

Clause 54. The article of footwear of clause 52 or 53, wherein: the layers include a third layer disposed adjacent to the second layer with the second layer between the first layer and the third layer; and wherein the third layer has a third hardness different than the second hardness.

Clause 55. The article of footwear of any of clauses 52-54, wherein the protrusion includes the first layer and the second layer and not the third layer.

Clause 56. The article of footwear of any of clauses 52-55, wherein the protrusion extends laterally across a longitudinal midline of the monolithic component.

Clause 57. The article of footwear of any of clauses 52-56, wherein the protrusion extends fore and aft in a nonlinear orientation.

Clause 58. The article of footwear of any of clauses 52-57, wherein the first layer includes discrete strips extending transversely from a medial side to a lateral side of the sole structure.

Clause 59. The article of footwear of any of clauses 52-58, wherein: a proximal side of the first layer and a distal side of the second layer meet at and define an interface; the first layer has a first color at the interface and the second layer has a second color different than the first color at the interface.

Clause 60. The article of footwear of any of clauses 52-59, wherein at least one of the layers has a recess extending partway or completely through a thickness of the at least one of the layers.

Clause 61. The article of footwear of any of clauses 52-60, wherein the first layer defines a through hole extending through the first layer and exposing at least one other of the layers at the through hole.

Clause 62. The article of footwear of any of clauses 43-47, wherein: at least two of the layers have discrete, discontinuous sections; and the sections of at least two of the layers are stacked in a different order relative to one another in a first region of the article of footwear than in a second region of the article of footwear.

Clause 63. The article of footwear of any of clauses 43-47, wherein at least one of the layers defines a plurality of medial fingers at a medial extent of the at least one of the layers and establishing a medial edge of the at least one of the layers, and a plurality of lateral fingers at a lateral extent of the at least one of the layers and establishing a lateral edge of the at least one of the layers.

Clause 64. The article of footwear of any of clauses 43-63, wherein the layers are uncured rubber.

Clause 65. The article of footwear of any of clauses 43-63, wherein the layers are thermoplastic polyurethane.

Clause 66. A method of manufacturing an article of footwear specifically of any of clauses 43-65, the method comprising: stacking multiple layers without adhesive between adjacent ones of the multiple layers; after the stacking, heating and, optionally, pressing the multiple layers as a monolithic component of a sole structure of the article of footwear such that adjacent ones of the layers are secured to one another by thermal bonding; wherein the monolithic component has a distal side and a proximal side, the layers being stacked in a direction from the proximal side to the distal side; and wherein at least two of the layers are exposed at the distal side and have at least one different property.

Clause 67. An article of footwear comprising a sole structure configured as a monolithic component comprising regions of cured rubber disposed in a direction from a proximal side of the monolithic component to a distal side of the monolithic component, each of the regions having at least one different property than each of the other regions, with adjacent ones of the regions secured to one another by cross-linking and without adhesive therebetween, and at least two of the regions exposed at the distal side.

Clause 68. A method of manufacturing an article of footwear, the method comprising: stacking multiple uncured rubber layers without adhesive between adjacent ones of the multiple uncured rubber layers; after the stacking, curing the multiple uncured rubber layers as a monolithic component of a sole structure of the article of footwear such that monolithic component includes regions corresponding with adjacent ones of the uncured rubber layers, the cured rubber of each region secured to the cured rubber of each adjacent region by cross-linking; wherein the monolithic component has a distal side and a proximal side, the regions arranged in a direction from the proximal side to the distal side; and wherein at least two of the regions are exposed at the distal side and have at least one different property.

To assist and clarify the description of various embodiments, various terms are defined herein. Unless otherwise indicated, the following definitions apply throughout this specification (including the claims). Additionally, all references referred to are incorporated herein in their entirety.

An “article of footwear”, a “footwear article of manufacture”, and “footwear” may be considered to be both a machine and a manufacture. Assembled, ready to wear footwear articles (e.g., shoes, sandals, boots, etc.), as well as discrete components of footwear articles (such as a midsole, an outsole, an upper component, etc.) prior to final assembly into ready-to-wear footwear articles, are considered and alternatively referred to herein in either the singular or plural as “article(s) of footwear”.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms "comprising", “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term "or" includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

The term “longitudinal” particularly refers to a direction extending a length of a component. For example, a longitudinal direction of a shoe extends between a forefoot region and a heel region of the shoe. The term “forward” or “anterior” is used to particularly refer to the general direction from a heel region toward a forefoot region, and the term “rearward” or “posterior” is used to particularly refer to the opposite direction, i.e., the direction from the forefoot region toward the heel region. In some cases, a component may be identified with a longitudinal axis as well as a forward and rearward longitudinal direction along that axis. The longitudinal direction or axis may also be referred to as an anterior-posterior direction or axis.

The term “transverse” particularly refers to a direction extending a width of a component. For example, a transverse direction of a shoe extends between a lateral side and a medial side of the shoe. The transverse direction or axis may also be referred to as a lateral direction or axis or a mediolateral direction or axis.

The term “vertical” particularly refers to a direction generally perpendicular to both the lateral and longitudinal directions. For example, in cases where a sole is planted flat on a ground surface, the vertical direction may extend from the ground surface upward. It will be understood that each of these directional adjectives may be applied to individual components of a sole. The term “upward” or “upwards” particularly refers to the vertical direction pointing towards a top of the component, which may include an instep, a fastening region and/or a throat of an upper. The term “downward” or “downwards” particularly refers to the vertical direction pointing opposite the upwards direction, toward the bottom of a component and may generally point towards the bottom of a sole structure of an article of footwear.

The “interior” of an article of footwear, such as a shoe, particularly refers to portions at the space that is occupied by a wearer’s foot when the shoe is worn. The “inner side” of a component particularly refers to the side or surface of the component that is (or will be) oriented toward the interior of the component or article of footwear in an assembled article of footwear. The “outer side” or “exterior” of a component particularly refers to the side or surface of the component that is (or will be) oriented away from the interior of the shoe in an assembled shoe. In some cases, other components may be between the inner side of a component and the interior in the assembled article of footwear. Similarly, other components may be between an outer side of a component and the space external to the assembled article of footwear. Further, the terms “inward” and “inwardly” particularly refer to the direction toward the interior of the component or article of footwear, such as a shoe, and the terms “outward” and “outwardly” particularly refer to the direction toward the exterior of the component or article of footwear, such as the shoe. In addition, the term “proximal” particularly refers to a direction that is nearer a center of a footwear component, or is closer toward a foot when the foot is inserted in the article of footwear as it is worn by a user. Likewise, the term “distal” particularly refers to a relative position that is further away from a center of the footwear component or is further from a foot when the foot is inserted in the article of footwear as it is worn by a user. Thus, the terms proximal and distal may be understood to provide generally opposing terms to describe relative spatial positions.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

While several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An article of footwear comprising:
a sole structure including:
rubber layers stacked on one another;
wherein adjacent ones of the rubber layers are secured to one another with cross-linking and without adhesive such that the rubber layers define a monolithic component having a proximal side and a distal side, the rubber layers being stacked in a direction from the proximal side to the distal side; and
wherein at least two of the rubber layers are exposed at the distal side, and have at least one different property.

2. The article of footwear of claim 1, wherein the at least two of the rubber layers at least partially define a ground contact surface of the sole structure at the distal side.

3. The article of footwear of claim 2, wherein the at least two of the rubber layers defining the ground contact surface comprise an outsole.

4. The article of footwear of claim 3, further comprising:
a footwear upper; and
wherein the monolithic component wraps upward onto and is secured to the footwear upper at a medial side of the footwear upper and at a lateral side of the footwear upper.

5. The article of footwear of claim 4, the sole structure further comprising:
a drop-in midsole disposed in a foot-receiving cavity of the article of footwear.

6. The article of footwear of claim 2, wherein the sole structure further includes a foam midsole layer disposed inward of the proximal side of the monolithic component.

7. The article of footwear of claim 1, wherein:
the at least two of the rubber layers include a first rubber layer and a second rubber layer;
the first rubber layer and the second rubber layer define a protrusion at the distal side of the article of footwear;
the first rubber layer is disposed as an outermost portion of the protrusion along a vertical axis of the protrusion; and
the second rubber layer is exposed along the protrusion proximal to the first rubber layer.

8. The article of footwear of claim 1, wherein:
at least two of the rubber layers have discrete, discontinuous sections; and/or
the sections of at least two of the rubber layers are stacked in a different order relative to one another in a first region of the article of footwear than in a second region of the article of footwear.

9. The article of footwear of claim 1, wherein at least one of the rubber layers defines a plurality of medial fingers at a medial extent of the at least one of the rubber layers and establishing a medial edge of the at least one of the rubber layers, and a plurality of lateral fingers at a lateral extent of the at least one of the rubber layers and establishing a lateral edge of the at least one of the rubber layers.

10. The article of footwear of claim 1, wherein the rubber layers include:
a first rubber layer that has a plurality of discrete sections spaced apart from one another;
a second rubber layer having a distal side secured to a proximal side of the discrete sections of the first rubber layer; and
an additional rubber layer that has a proximal side that interfaces with the distal side of the second rubber layer and with the proximal side of at least one of the discrete sections and is cross-linked thereto, and interfaces with a distal side of at least one other of the discrete sections and is cross-linked thereto.

11. The article of footwear of claim 1, wherein the at least one different property is at least one of a different color, transparency, translucency, hardness, elastic modulus, thickness, material, or grade of material.

12. A method of manufacturing an article of footwear, the method comprising:
stacking multiple uncured rubber layers without adhesive between adjacent ones of the multiple uncured rubber layers;
after the stacking, curing the multiple uncured rubber layers as a monolithic component of a sole structure of the article of footwear such that adjacent ones of the rubber layers are secured to one another by cross-linking;
wherein the monolithic component has a distal side and a proximal side, the rubber layers being stacked in a direction from the proximal side to the distal side; and
wherein at least two of the rubber layers are exposed at the distal side and have at least one different property.

13. The method of manufacturing the article of footwear of claim 12, wherein the at least two of the rubber layers at least partially define a ground contact surface of the sole structure.

14. The method of manufacturing the article of footwear of claim 12, wherein the at least two of the rubber layers include a first rubber layer and a second rubber layer, and the method of manufacturing the article of footwear further comprising:
forming or cutting the rubber layers either prior to or after the curing such that:
at least the first rubber layer and the second rubber layer define a protrusion at the distal side of the monolithic component;
the first rubber layer is disposed as an outermost portion of the protrusion along a vertical axis of the protrusion; and
the second rubber layer is exposed along the protrusion proximal to the first rubber layer.

15. The method of manufacturing the article of footwear of claim 12, wherein the at least two of the rubber layers include a first rubber layer and a second rubber layer, and the method of manufacturing an article of footwear further comprising:
forming or cutting through holes in at least the first rubber layer and the second rubber layer prior to the stacking; and
wherein the stacking multiple uncured rubber layers includes at least partially aligning the through holes in the first rubber layer with the through holes in the second rubber layer.

16. The method of manufacturing the article of footwear of claim 12, wherein:
the at least two of the rubber layers include a first rubber layer and a second rubber layer;
the stacking multiple uncured rubber layers includes registering the first rubber layer to a mold within a mold cavity of the mold prior to stacking the second rubber layer on the first rubber layer; and
the curing is in the mold.

17. The method of manufacturing the article of footwear of claim 12, wherein the at least two of the rubber layers include a first rubber layer and a second rubber layer, and the method of manufacturing an article of footwear further comprising:
forming or cutting through holes in at least the first rubber layer and the second rubber layer either prior to or after the stacking and prior to the curing; and
ejecting cut portions of the stacked multiple layers at the through holes via a die.

18. The method of manufacturing the article of footwear of claim 12, wherein the stacking multiple uncured rubber layers is in a mold, and the method of manufacturing the article of footwear further comprising:
injecting foam into the mold to form a foam midsole layer and such that the injected foam extends through the at least partially aligned through holes; or
placing a preform of a foam midsole layer in the mold prior to the curing such that the preform forms a foam midsole layer and the monolithic component thermally bonds to the foam midsole layer during or after the curing; or
placing a footwear upper in the mold prior to the curing such that the monolithic component thermally bonds to the footwear upper during or after the curing.

19. The method of manufacturing of claim 12, wherein the at least two of the rubber layers exposed at the distal side of the monolithic component include a first uncured rubber layer having discrete sections spaced apart from one another and a second uncured rubber layer interfacing with a proximal side of the discrete sections of the first uncured rubber layer, and wherein the stacking multiple uncured rubber layers includes:
intertwining an additional uncured rubber layer with the discrete sections of the first uncured rubber layer so that the additional uncured rubber layer interfaces with a distal side of at least one of the discrete sections and with the proximal side of at least one other of the discrete sections.

20. A method of manufacturing an article of footwear, the method comprising:
stacking multiple uncured rubber layers without adhesive between adjacent ones of the multiple uncured rubber layers and such that through holes of at least some of the stacked multiple uncured layers are at least partially aligned with one another; and
curing the stacked multiple uncured rubber layers as a monolithic component such that adjacent ones of the rubber layers are secured to one another by cross-linking.
